(19) United States
(12) Patent Application Publication
(10) Pub. No.: US 2009/0205280 A1
(43) Pub. Date: Aug. 20, 2009

(54) Thermal and Sound Building Insulation Panels Having Internal Vacuum

(76) Inventor: Eldon Coppersmith, Lakewood, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/354,316

(22) Filed: Jan. 15, 2009

Related U.S. Application Data
(60) Provisional application No. 61/029,010, filed on Feb. 15, 2008.

(51) Int. Cl. E04B 1/74; B21K 23/00; B32B 3/02

(52) U.S. Cl. 52/506.01; 29/897.3; 428/80

(57) ABSTRACT

According to the invention, a system for insulating a structure is disclosed. The system may include an insulation panel. The insulation panel may define an internal volume. The internal volume may be at a lower pressure than an exterior of the insulation panel. The insulation panel may be disposed within a portion of the structure.

### BACKGROUND OF THE INVENTION

This invention relates generally to building materials for construction of buildings. More specifically the invention relates to vacuum panels for thermal and sound insulation of buildings.

It has been known for many decades that sound can not be transmitted through a vacuum, and that heat can not be transferred through a vacuum by conduction nor by convection. A thermal insulation system including a vacuum, and also reflective surfaces which reflect heat in the form of radiation, infrared radiation for example, may produce a very high thermal R value.

A Dewar's vessel, commonly known as a Thermos bottle, was first produced in about 1904. It comprises a vacuum space which almost completely eliminates heat transfer by conduction and convection. It also comprises reflective surfaces, reflective metal foil, or silver-coated glass for example, which reflect a high percentage of heat in the form of radiation, infrared radiation for example. Such a Thermos bottle may thereby provide a thermal R value of approximately R 250.

At the time of this writing, there is apparently no insulation system including a vacuum and reflective surfaces in a form suitable for permanent use in buildings and other structures. This is due, among other reasons, to the fact that vacuum panels that exist at the time of this writing apparently can not maintain a vacuum for long enough of a time period as to be acceptable for use as a permanent component of a building. The use of prior art vacuum insulation panels, at the time of this writing is apparently basically restricted to more short-term applications in for example, refrigeration and freezer units, etc.

At the time of this writing there are in existence vacuum insulation panels of a very different form, structure, constituent materials, and manufacturing method than the present invention insulation panels. These prior art panels are used in such places as appliances, furnaces, freezers, refrigerators, trucks, etc., but typically not in buildings.

Generally, prior art panels comprise a core material enveloped in various plastic and metal foils. The core material prevents the panel from collapsing upon itself when the vacuum is applied. Getters and desiccants may be placed inside the panel to help maintain as complete of a vacuum as possible for as long of a period of time as possible. The foil envelope is then sealed.

Prior art panels have shortcomings that prevent their use as long term or permanent components of buildings. The shortcomings may include, but may not be limited to the following:
(1) they are fragile;
(2) the core materials and enveloping materials outgas molecules into the vacuum space and gradually destroy, or reduce the completeness of the vacuum;
(3) getters and desiccants are needed inside of the vacuum space in an attempt to eliminate outgassed molecules that accumulate in the vacuum space;
(4) the seals of the foil envelopes may leak; and
(5) the prior art panels apparently do not maintain their vacuum nor their thermal R value for long enough of a period of time as to be acceptable for use in buildings. They apparently last between approximately 10 and 25 years.

It would be advantageous to provide a vacuum insulation panel appropriately designed for permanent use in buildings.

The amount of energy used in the United States and the world in a single year for heating and cooling purposes is quite large, and the percentage of that amount which is lost through walls, floors, ceilings, etc. is in turn quite large.

Present invention insulation panels therefore also relate to energy conservation and to reducing environmental pollutants, including greenhouse gasses such as carbon dioxide, which are produced when energy for heating and cooling buildings and other structures is consumed.

### BRIEF DESCRIPTION OF THE INVENTION

Historically, a device having internal vacuum, such as an electronic fuse, a light bulb, or a Dewar's vessel for example, resist collapse by being round, cylindrically round, spherical, etc., and therefore geometrically rigid. A concept of novelty of the present invention may be that of the evacuation and controlled partial implosion or controlled partial collapse of a non-rigid device, in this case a non-rigid panel precursor, in producing a device, in this case an insulation panel, of a desired size and shape with an internal vacuum permanently retained therein. The evacuation is one of the factors that produces or determines the final size and shape of the evacuated insulation panel. Also, the permanently retained internal vacuum is one factor that permanently maintains the size and shape of the evacuated insulation panel. The first and second walls of the evacuated insulation panel retain their desired size and shape by the forces acting thereon being in static equilibrium. Simply stated, the force of atmospheric pressure and the “force” of internal vacuum exerting inwardly-directed force on the walls, is in equilibrium with the force of the inertial tendency of the walls to retain or return to the convexly curved shape of the walls of the pre-evacuation panel precursor and the force of an optional adjustable pressure-exerting band exerting outwardly-directed force on the walls. Another concept of novelty may be the use of an optional adjustable pressure-exerting band of which two types are exemplified in this writing, located on the inner surface of the walls and exerting outwardly-directed pressure during the evacuation process and permanently thereafter.

The present invention teaches an evacuated building insulation panel used as thermal and sound insulation, permanently installed in, for example, walls, ceilings, roofs, attics, etc. of buildings, and used in other structures also.

The present invention teaches that there may be advantageous sizes for such panels and the insulation material in which they may be encapsulated, i.e. sizes that fit into commonly used dimensions of architectural cavities in buildings of common types of construction.

The present invention teaches an evacuated building insulation panel which may be produced by evacuating a single non-rigid panel precursor with a generally elliptical cross section and made of a suitable material, such as an alloy of aluminum for example, that is known not to outgas significantly and is appropriately malleable, ductile, resilient, flexible, rigid, etc., or in any case possesses the metallurgic and physical properties desired by the manufacturer. The evacuation thereof effects a controlled partial collapse, or controlled partial implosion, the result being an evacuated building insulation panel of the desired size, shape, etc. The panel may also be produced by evacuation of a plurality of inter-connected rigid chambers that may be resistant to collapse. The evacuated building insulation panel may be encapsulated in insulation material, a rigid or semi-rigid insulation material impermeable to moisture such as closed-cell polystyrene for example. The metal (or other material) may be sufficiently reflective, or reflective surfaces may be applied.

The present invention teaches a way to apply the thermal and sound insulation capabilities of a vacuum, the thermal insulation capabilities of reflective surfaces, and the thermal and sound insulation and moisture barrier capabilities of encapsulating insulation material in producing encapsulated thermal and sound insulation vacuum panels suitable for permanent use in buildings and other structures. Benefits include heat transfer reduction, sound transmission reduction, sound absorption, energy conservation, a reduction in environmental pollution including greenhouse gasses such as carbon dioxide, monetary savings for building owners, the possibility of manufacturing the present invention insulation panels at least partially of recycled material, and a reduction in dependence on energy imported from foreign countries.

The present invention teaches encapsulated, evacuated insulation panels which may be installed in walls, ceilings, attics, roofs, and floors, etc. of buildings and other structures and last long enough as to be a permanent component of buildings and other structures.

Other possible applications of the present invention insulation panels include, but may not be limited to, the insulation of exterior doors, recreational vehicles, swimming pools, ice hockey arenas, ice skating arenas, heating units, freezing units, cryogenic facilities, refrigeration units, large aquariums, large terrariums, greenhouses, power plants, facilities for livestock, poultry, and zoo animals, etc.

The present invention insulation panels may be most easily visually perceived by the reader as being in a vertical position “standing up” inside of the walls of a building. Some text and drawings however, refer to the insulation panels and so on in a horizontal position “laying down” during the manufacturing process, or installed on the attic floor of a building, etc. Also, the term “insulation panel” may refer to an encapsulated insulation panel.

In one embodiment, a system for insulating a structure is provided. The system may include an insulation panel. The insulation panel may define an internal volume. The internal volume may be at a lower pressure than an exterior of the insulation panel. The insulation panel may be disposed within a portion of the structure.

In another embodiment, a method for manufacturing an insulation panel is provided. The method may include providing a panel precursor, where the panel precursor may define an internal volume. The method may also include reducing the pressure of the internal volume. The method may further include sealing the internal volume from an exterior of the panel precursor to create the insulation panel.

In another embodiment, a structure having insulated walls is provided. The structure may include a wall and an insulation panel. The insulation panel may be disposed within or adjacent to the wall. The insulation panel may define an internal volume and the internal volume may be at a lower pressure than an exterior of the insulation panel.

Generally, the first part of this disclosure and FIGS. 1 through 12 for example, refer to vacuum insulation panels of evacuated generally rigid chambers. Generally, the second part and FIGS. 13 through 35b for example, refer to vacuum insulation panels produced by a controlled partial implosion or controlled partial collapse by evacuating generally non-rigid panel precursors. Whereas both types and combinations thereof may be contemplated, the second may be preferred at the time of this writing.

### BRIEF DESCRIPTION OF THE DRAWINGS

The present invention is described in conjunction with the appended Figures, many of which, FIGS. 17, 18, 27, and 28 for example, are “not to scale”.

FIG. 1 is a cross-sectional top view of an exemplary embodiment of the invention having round rigid elongated evacuated chambers;

FIG. 2 is a cross-sectional top view of an exemplary embodiment of the invention having elliptical rigid elongated evacuated chambers;

FIG. 3 is a cross-sectional top view of an exemplary embodiment of the invention having diamond-shaped rigid elongated evacuated chambers;

FIG. 4 is an elevational perspective view of an exemplary rigid embodiment of the invention during the course of manufacture;

FIG. 5 is an elevational perspective view of an exemplary embodiment of the invention showing a seal or cap on the end of the rigid elongated evacuated chambers;

FIG. 6 is an elevational perspective view of an exemplary rigid embodiment of the invention, depicting an embodiment having an evacuation port on the side;

FIG. 7 is an elevational perspective view of an exemplary embodiment of the invention having 17 rigid elongated evacuated chambers;

FIG. 8 is a cross-sectional view of wall (not to scale) showing placement of the invention in reference to electrical conduits or wires, electrical boxes and the like;

FIG. 9 is a cross sectional top view of an exemplary embodiment of the invention having no connection passages between rigid chambers of the panel;

FIG. 10 is a side view of an exemplary rigid embodiment depicting an exemplary extrusion resultant shape of chambers;

FIG. 11 is a cross sectional side view of a chamber showing the passages and supportive sections of an exemplary rigid embodiment;

FIG. 12 is a cross sectional side view of a chamber showing the passages and supportive sections of an exemplary rigid embodiment;

FIG. 13 is a cross-sectional view of wall (not to scale) showing placement of an embodiment of the invention in reference to electrical conduits or wires, electrical boxes and the like;

FIG. 14 is a perspective view of a non-rigid panel precursor and two types of optional adjustable pressure-exerting bands during the course of manufacture;

FIG. 15a and FIG. 15b are a pair of cross-sectional end views of a non-rigid embodiment of the invention, respectively prior to evacuation and after evacuation;

FIG. 15c and FIG. 15d are a pair of cross-sectional end views of an alternatively-shaped non-rigid embodiment of the invention, respectively prior to evacuation and after evacuation;

FIG. 15e and FIG. 15f are a pair of cross-sectional end views of a second alternatively-shaped non-rigid embodiment of the invention, respectively prior to evacuation and after evacuation;

FIG. 15g and FIG. 15h are a pair of cross-sectional end views of a third alternatively-shaped non-rigid embodiment of the invention, respectively prior to evacuation and after evacuation;

FIG. 15i and FIG. 15j are a pair of cross-sectional end views of a fourth alternatively-shaped non-rigid embodiment of the invention, respectively prior to evacuation and after evacuation;

FIG. 15k is a top view of an embodiment of the invention exemplifying FIGS. 15g, 15h, 15i, and 15j and showing details of manufacture;

FIG. 16 is a side view of an optional rod-shaped spacer/center support component that may be used in the invention;

FIG. 17 is a partially transparent perspective view showing details of a non-rigid embodiment of the invention and construction thereof;

FIG. 18 is a partially transparent perspective view showing details of a non-rigid embodiment of the invention and construction thereof;

FIG. 19 is a perspective view showing details of construction techniques of a non-rigid embodiment of the invention;

FIG. 20 is a perspective view showing details of construction techniques of a non-rigid embodiment of the invention;

FIG. 21 is a perspective view showing details of construction techniques of a non-rigid embodiment of the invention;

FIG. 22 is a cross-sectional side view of a non-rigid embodiment of the invention, showing details of manufacture;

FIG. 23 is a cross-sectional side view of one alternative of a non-rigid embodiment of the invention, showing details of manufacture;

FIG. 24 is a perspective end-view of one alternative of a non-rigid embodiment of the invention, showing details of manufacture;

FIG. 25 is a cross-sectional side view of one alternative of a non-rigid embodiment of the invention, showing details of manufacture;

FIG. 26a and FIG. 26b show sealing of a non-rigid embodiment of the invention during manufacture;

FIG. 27 is a partially transparent perspective view showing details of a non-rigid embodiment of the invention and construction thereof;

FIG. 28 is a partially transparent perspective view showing details of a non-rigid embodiment of the invention and construction thereof;

FIG. 29a and FIG. 29b are a pair of side views of the non-rigid panel precursor pre-evacuation and the insulation panel post evacuation of a non-rigid embodiment of the invention;

FIG. 30 is an end view of a non-rigid embodiment of the invention showing details of manufacture;

FIG. 31 is a cross-sectional side view of a non-rigid embodiment of the invention, showing details of manufacture;

FIG. 32 is a side view of a non-rigid embodiment of the invention;

FIG. 33a and FIG. 33b are a pair of side views of a non-rigid embodiment of the invention, pre-evacuation and post-evacuation;

FIG. 34 is a perspective side view of an alternative of a non-rigid embodiment of the invention; and

FIG. 35a and FIG. 35b are cross-sectional side views of an alternative of an embodiment of the invention showing details of manufacture.

### INDEX TO REFERENCE NUMERALS IN THE DRAWINGS

| | |
|---|---|
| Rigid building insulation panel | 100 |
| Rigid elongated evacuation chambers | 102a, 102b, 102c, 102d |
| Interior space | 104 |
| Passage | 106 |
| Rigid building insulation panel | 200 |
| Rigid elongated evacuation chambers | 202a, 202b, 202c, 202d |
| Interior space | 204 |
| Passage | 206 |
| Rigid building insulation panel | 300 |
| Rigid elongated evacuation chambers | 302a, 302b, 302c, 302d |
| Interior space | 304 |
| Passage | 306 |
| Rigid building insulation panel | 400 |
| Interior | 404 |
| Seal/cap | 550 |
| Evacuation port | 660 |
| Rigid building insulation panel | 700 |
| Exterior siding & interior finished wall material | 802a, 802b |
| Top and bottom wall framing | 804a, 804b |
| Electrical boxes | 806a, 806b |
| Wall interior electrical conduit/wire | 808 |
| Conventional materials/space | 810 |
| Evacuated insulation panel | 812 |
| Encapsulating insulation material | 814 |
| Rigid building insulation panel | 900 |
| Rigid elongated evacuation chambers | 902a, 902b, 902c, 902d |
| Interior space | 904 |
| Rigid chamber | 1002 |
| Rigid chamber shape | 1004 |
| Passage | 1102 |
| Supportive section | 1104 |
| Passage | 1202 |
| Supportive section | 1204 |
| Electrical conduit/wire | 1302 |
| Electrical boxes such as light switch and outlet box | 1304 |
| Exterior siding | 1306 |
| Interior finished wall material | 1308 |
| Evacuated insulation panel | 1312 |
| Conventional materials/space | 1313 |
| Encapsulating insulation material | 1314 |
| Nominal 2 × 6 top and bottom wall framing | 1315 |
| Non-rigid panel precursor | 1402 |
| Optional adjustable elliptical vertically-oriented | 1404 |
| pressure-exerting band pre-compression | |
| Optional adjustable elliptical horizontally-oriented | 1406 |
| pressure-exerting band compressed | |
| Alternatively-designed optional convexo-concave | 1408 |
| shaped adjustable pressure-exerting band “closed” | |
| Alternatively-designed optional half moon-shaped | 1410 |
| adjustable pressure-exerting band “released” | |
| Non-rigid panel precursor and pre-evacuation interior space | 1502 |
| Collapse-resistant side edge | 1506 |
| First and second walls | 1508 |
| Insulation panel and post-evacuation interior space | 1510 |
| Alternatively-shaped non-rigid panel precursor and | 1512 |
| pre-evacuation interior space | |
| Alternatively-shaped insulation panel and | 1514 |
| post-evacuation interior space | |
| Alternatively-shaped first and second walls | 1516 |
| Second alternatively-shaped non-rigid panel | 1518 |
| precursor and pre-evacuation interior space | |
| Second alternatively-shaped insulation panel and | 1520 |
| post-evacuation interior space | |
| Second alternatively-shaped first and second walls | 1522 |
| Third alternatively-shaped non-rigid panel precursor and | 1524 |
| pre-evacuation interior space | |
| Third alternatively-shaped insulation panel and | 1526 |
| post-evacuation interior space | |
| Third alternatively-shaped first and second walls | 1528 |
| Downwardly-exerted pressure | 1529 |
| Fourth alternatively-shaped non-rigid panel precursor and | 1530 |
| pre-evacuation interior space | |
| Fourth alternatively-shaped insulation panel and | 1532 |
| post-evacuation interior space | |
| Fourth alternatively-shaped first and second walls | 1534 |
| Downwardly-exerted pressure | 1535 |
| Two adaptors and bifurcated evacuation hose | 1540 |
| Length throughout which downwardly-exerted | 1542 |
| pressure may be applied | |
| Sealed ends | 1544 |
| Severing locations | 1546 |
| Open ends | 1548 |
| Optional rod-shaped spacer/center support component | 1602 |
| Tapered end | 1604 |
| Flattened section | 1606 |
| Non-rigid panel precursor | 1702 |
| Optional adjustable pressure-exerting band | 1704 |
| Potential collapse area | 1706 |
| Sealed end | 1708 |
| Open end | 1710 |
| Adaptor | 1712 |
| Evacuation hose | 1714 |
| Excess material, severed and recycled | 1716 |
| Second seal | 1718 |
| Rimmed size & shape retainer with opening(s) | 1802 |
| Non-rigid panel precursor | 1804 |
| Optional adjustable pressure-exerting band | 1806 |
| Adaptor | 1902 |
| Evacuation hoses | 1904a, 1904b |
| Non-rigid panel precursor | 1906 |
| Adaptor | 2002 |
| Bifurcated evacuation hose | 2004 |
| Non-rigid panel precursor | 2006 |
| Adaptor | 2102 |
| Evacuation hose | 2104 |
| Non-rigid panel precursor | 2106 |
| Adaptor | 2202 |
| Evacuation hose | 2204 |
| Non-rigid panel precursor | 2206 |
| Elastic band | 2208 |
| Adaptor | 2302 |
| Evacuation hose | 2304 |
| Non-rigid panel precursor | 2306 |
| Elastic band | 2308 |
| Rimmed size & shape retainer with opening(s) | 2310 |
| Adaptor | 2402 |
| Rimmed size & shape retainer with opening(s), not visible | 2410 |
| Exemplary clamp | 2412 |
| Slotted size & shape retainer/adaptor with opening(s) and hose(s) | 2502 |
| Non-rigid panel precursor | 2504 |
| Non-rigid panel precursor pre-seal | 2600a |
| Non-rigid panel precursor sealed | 2600b |
| Non-rigid panel precursor | 2702 |
| Punctured hole | 2704 |
| Sealed end | 2705 |
| Sealed end | 2706 |
| Third seal | 2707 |
| Evacuation attachment/sealer | 2708 |
| Excess material, severed and recycled | 2710 |
| Optional adjustable pressure-exerting band | 2712 |
| Non-rigid panel precursor | 2802 |
| Punctured hole | 2804 |
| Sealed end | 2805 |
| Evacuation attachment/sealer | 2806 |
| Sealed end | 2807 |
| Excess material, severed and recycled | 2808 |
| Third seal | 2809 |
| Optional adjustable pressure-exerting band | 2810 |
| Permanently-installed slotted barrier/flange/evacuation port | 3002 |
| Permanently-installed slotted barrier/flange/evacuation port | 3102 |
| Opening retainer | 3104 |
| Non-rigid panel precursor | 3106 |
| Non-rigid panel precursor | 3202 |
| Convex end | 3204 |
| Sealable end | 3206 |
| Evacuation port | 3208 |
| Non-rigid panel precursor pre-evacuation | 3302a |
| Evacuated building insulation panel | 3302b |
| Non-rigid first section | 3402a |
| Non-rigid second section | 3402b |
| Evacuation port | 3502a, 3502b |
| Severing location | 3504 |
| Evacuation port after evacuation and sealing | 3506 |
| Evacuation hose | 3508a, 3508b |
| Optional collar | 3510 |
| Optional plate | 3512 |

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements and sequence of steps of manufacturing without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, systems, networks, processes, and other elements in the invention may be shown as components in block diagram form in order not to obscure the embodiments in unnecessary detail. In other instances, well-known processes, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a procedure, etc.

Present invention vacuum insulation panels may be designed specifically for use in residential, commercial, and industrial buildings, and other structures, and overcome the shortcomings of prior art vacuum insulation panels according to the following description.

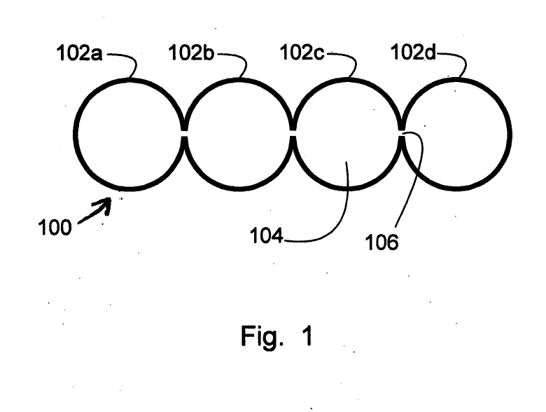

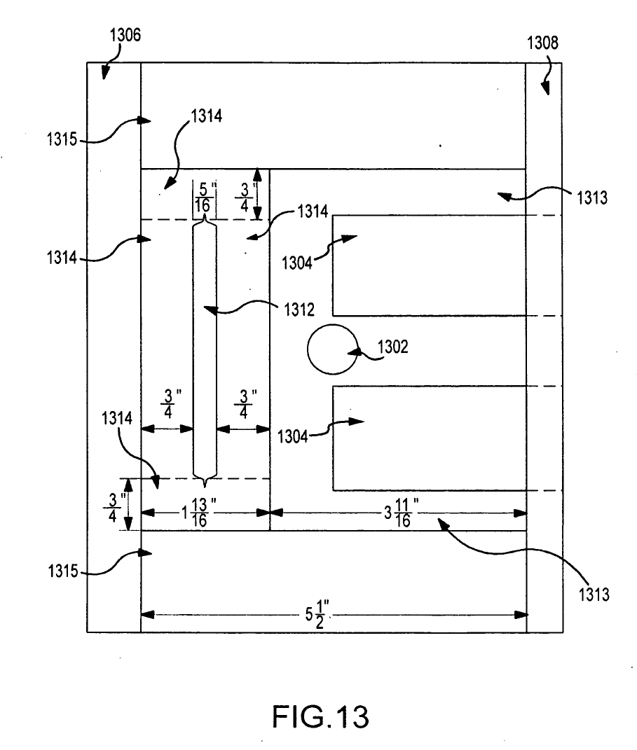

In general, present invention insulation panels may be generally rigid embodiments as generally depicted in FIGS. 1 through 12 for example, or may be generally non-rigid embodiments as generally depicted in FIGS. 13 through 35b for example. Whereas both rigid and non-rigid embodiments are herein described, non-rigid embodiments may be preferred at the time of this writing.

Present invention insulation panels may be generally shaped like a thin, flat, rectangular panel. They may be constructed entirely of one material, either a suitable metal, possibly a form of stainless steel or aluminum for example, or else a suitable type of glass, or other suitable material. A type of metal or a type of glass known not to outgas significantly may be examples of suitable materials of which to construct present invention insulation panels. However, it is possible that other materials may be suitable, and may be used. Some of these materials may be, for example, a type of metal or glass, or possibly another material that does not outgas significantly and may not need getters and/or desiccants. In general, either metal or glass insulation panels may be made, at least partially, of recycled metal or glass.

Both metal and glass may be materials that may be used to form an insulation panel which may be successfully sealed, without leaking seams, such that it may contain a vacuum indefinitely, or “permanently”, or at least for enough years so as to make present invention insulation panels suitable for use in buildings and other structures. As is described elsewhere in this writing, present invention insulation panels, whether made of metal or of glass, or possibly of another material, may be completely encapsulated in a protective, rigid or semi-rigid, conventional insulation material such as, for example, closed-cell polystyrene, polyisocyanurate, or polyurethane. The encapsulating insulation material may be in direct contact with the panel, or may be sized, shaped, and configured to comprise an air space between the panel and the encapsulating material.

### TERMINOLOGY

For the purpose of this disclosure, subjunctive words such as “may be”, “may seal”, and “may produce”, for example, are not meant to be construed as limiting, but rather are meant to be generally interchangeable with their corresponding indicative word forms such as “is”, “seals”, and “produces”, for example, and vice-versa.

References to various embodiments and/or various variations in this disclosure indicate that a feature, component, structure, characteristic, method, procedure, technique, etc. therein described or alluded to may be applicable to any embodiment and/or any variation and/or any combination thereof of the present invention.

Terms such as seal, seals, may seal, sealing, sealed, may be sealed, etc., for example, may refer for example to such materials and/or methods including but not limited to applying pressure, heating, rolling, folding, crimping, welding, electric resistance welding, friction welding, linear vibration welding, ultrasonic welding, brazing, flameless brazing, induction brazing, soldering, adhesive tape, adhesive film, aluminum to aluminum glue etc., and/or any combination thereof and/or any other suitable materials and/or methods that may be used to seal present invention panel precursors and/or vacuum insulation panels and/or any parts thereof.

As used herein, the term rigid may be construed to mean for example semi-rigid, generally rigid, substantially rigid, and/or temporarily rigid. As used herein, the term non-rigid may be construed to mean for example generally non-rigid, substantially non-rigid, and/or temporarily non-rigid.

FIG. 1 is a cross-sectional top view of an embodiment of the invention having round rigid elongated evacuated chambers. Building insulation panel 100 has a body made of a plurality of rigid elongated chambers 102a, 102b, 102c, 102d. The elongated chambers 102a-d should be rigid enough to support not only their own weight but also the process of evacuation to a very low internal pressure, a substantial vacuum inducing a low degree of sound transmission and conductive and convective heat transmission across the void interior space 104.

Passage 106 allows gasses within the interior space 104 to pass from one chamber to another and allows the possibility that a single evacuation port located anywhere on the panel may be used to evacuate the entire panel.

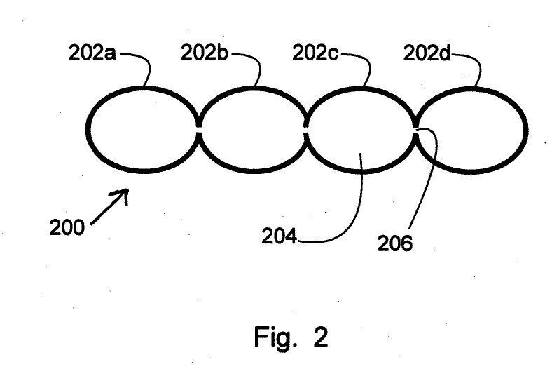

FIG. 2 is a cross-sectional top view of another embodiment of the invention having elliptical rigid elongated evacuation chambers. Building insulation panel 200 may be substantially similar to insulation panel 100, however, the cross-sectional shape of the rigid elongated evacuation chambers 202a, 202b, 202c, 202d may be elliptical rather than circular. The change from circular to elliptical allows a good deal of flexibility in design, as a given number or volume of evacuation chambers may be achieved by altering their shape and thus their thickness, volume and so on.

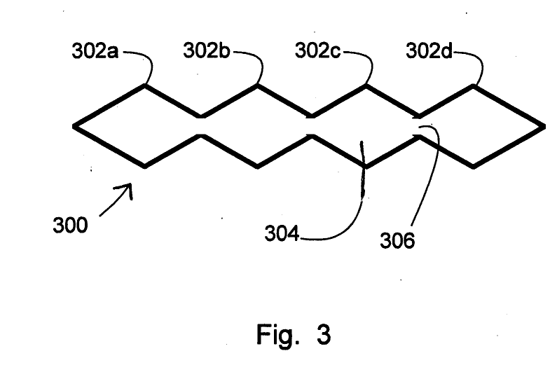

FIG. 3 is a cross-sectional top view of an embodiment of the invention having diamond-shaped rigid elongated evacuation chambers, and thus illustrating that the shape of the elongated chambers is not strictly limited in either cross section, size, dimension, longitudinal shape, and so on.

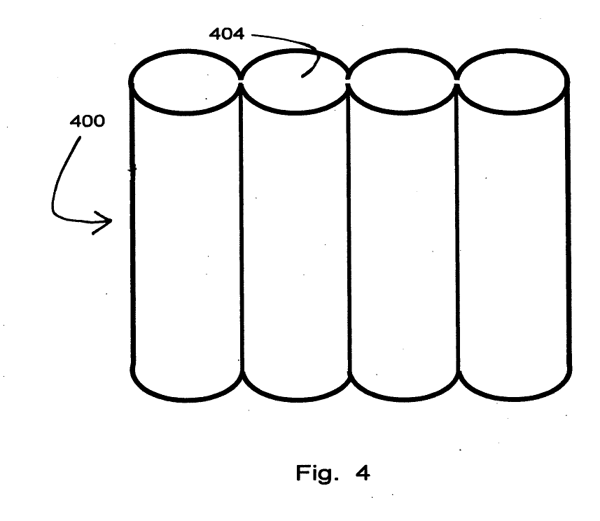

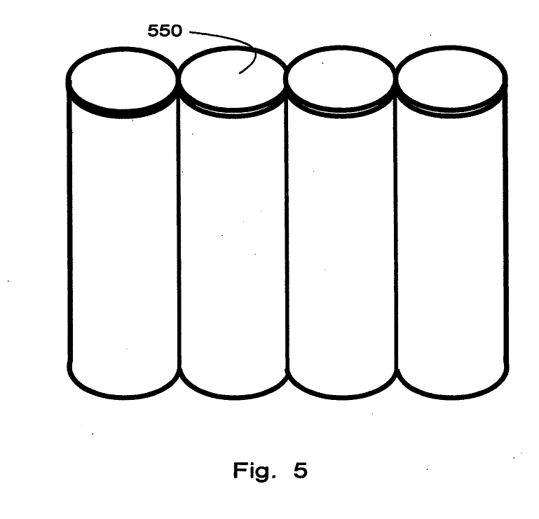

FIG. 4 is an elevational perspective view of an exemplary embodiment of the invention during the course of manufacture. Insulation panel body 400 may be open at the top (as with the three previous diagrams), thus showing the top end of interior 404. During manufacture, the interior space may be evacuated at this point, resulting in FIG. 5, which is an elevational perspective view of an exemplary embodiment of the invention showing a seal or cap on the end of the rigid elongated evacuation chambers. Seal/cap 550 may be created by forming of the end of the insulation panel, or may be a separate cap attached hermetically after evacuation, or similar procedures. Note that one advantageous shape for the rigid chambers would be to have one or two rounded or pointed ends, allowing for manufacture by continuous extrusion and sealing by applying pressure while the material may still be malleable. In that embodiment, the individual chambers may tend towards a ‘cigar’ shape with pointed ends.

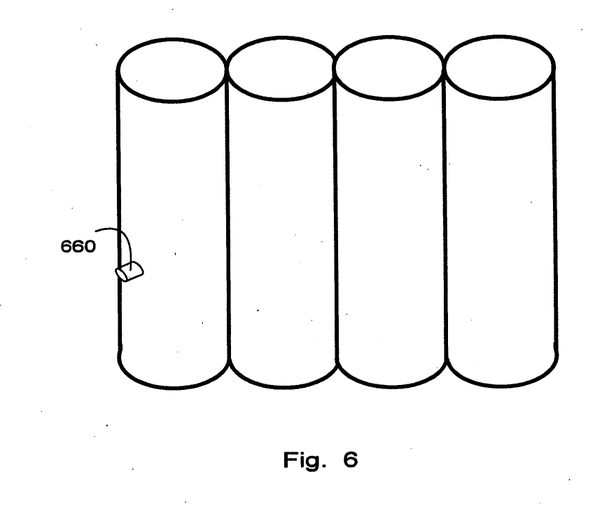

FIG. 6 is an elevational perspective view of an exemplary rigid embodiment of the invention, depicting an embodiment having an evacuation port on the side. Evacuation port 660 allows an even wider range of shapes that may be used.

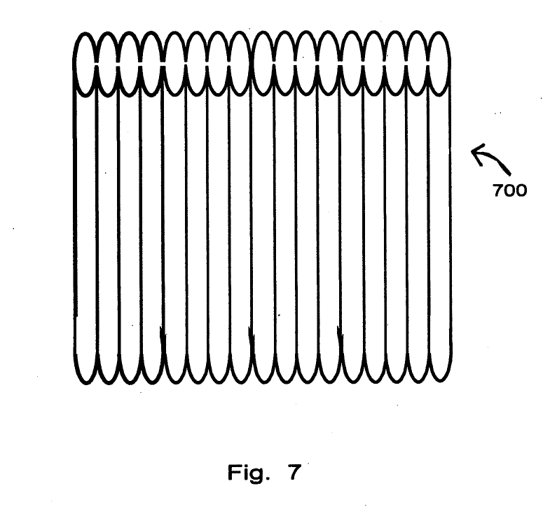

FIG. 7 is an elevational perspective view of an exemplary embodiment of the invention having seventeen rigid elongated evacuated chambers. The number of seventeen happens to be exemplary as seventeen chambers each with a diameter of approximately ⅝″ may constitute an example of a chamber of a width which, when encapsulated, may fit into an architectural cavity of a standard width in common construction.

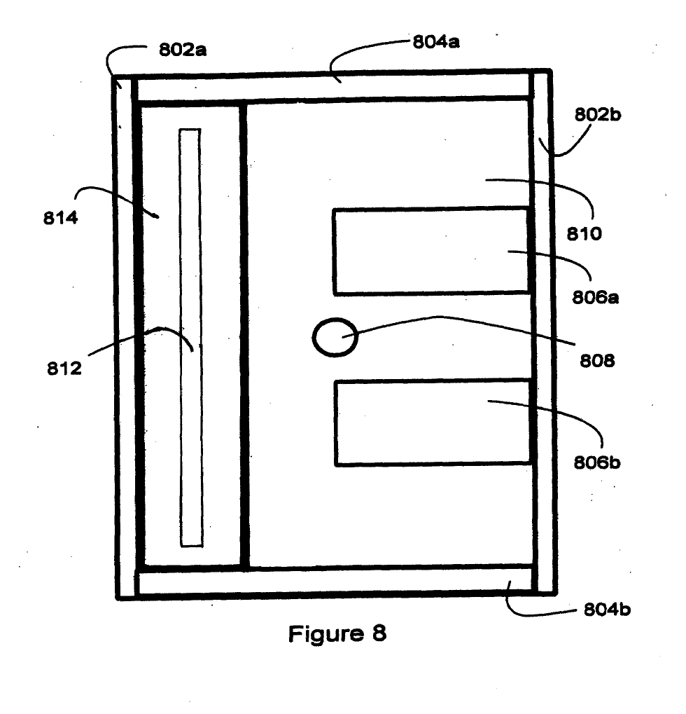

FIG. 8 is a cross-sectional view of wall (not to scale) showing placement of the invention in reference to electrical conduits or wires 808, electrical boxes 806a, 806b, and the like. Exterior siding 802a and interior finished wall material 802b and wood frames 804a, 804b define the exemplary interior of the wall seen in cross section. Evacuated insulation panel 812, encapsulated in encapsulating insulation material 814 is installed in the wall. Optional conventional materials, plumbing and electrical components, etc., may be in the available space 810.

FIG. 9 is a cross sectional top view of an exemplary embodiment of the invention having no connection passages between chambers of the panel. This embodiment and other passage-less embodiments of building insulation panel 900 have rigid elongated evacuated chambers 902a, 902b, 902c, 902d, but any individual interior space 904 may be interior to only a single elongated chamber (such as 902c) but not to 902a, 902b, or 902d, which have non-communicating interior chambers.

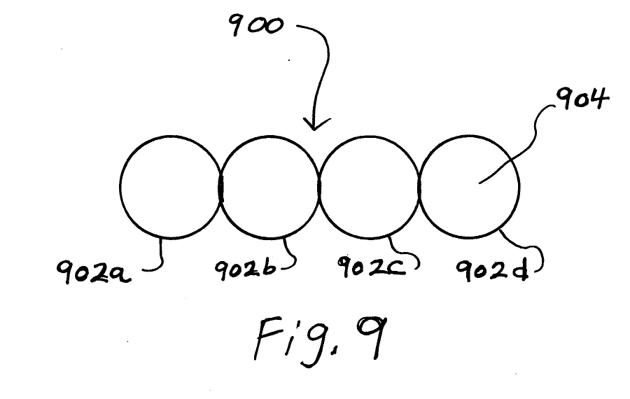

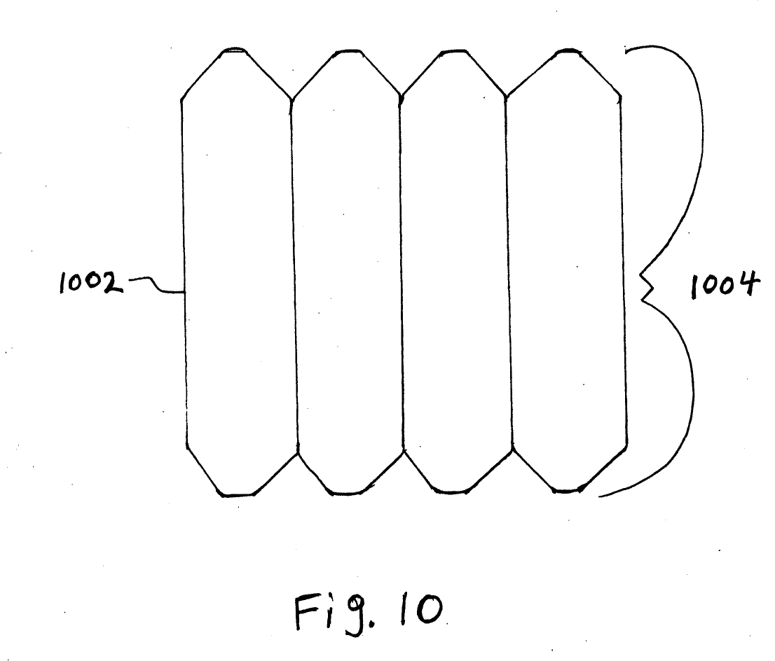

FIG. 10 is a side view of an exemplary embodiment depicting an exemplary embodiment showing a variation of extrusion resultant shape of chambers. Chamber 1002 may be seen to have a chamber shape 1004 which may be slightly “ovoid” or “cigar shaped” or “melted looking”. The rounded corners at 1004 may be considered as a sign of a simplified manufacture process more likely to yield lower cost chambers, that is, extrusion and evacuation methods which have some irregularities of shape but high speed of processing.

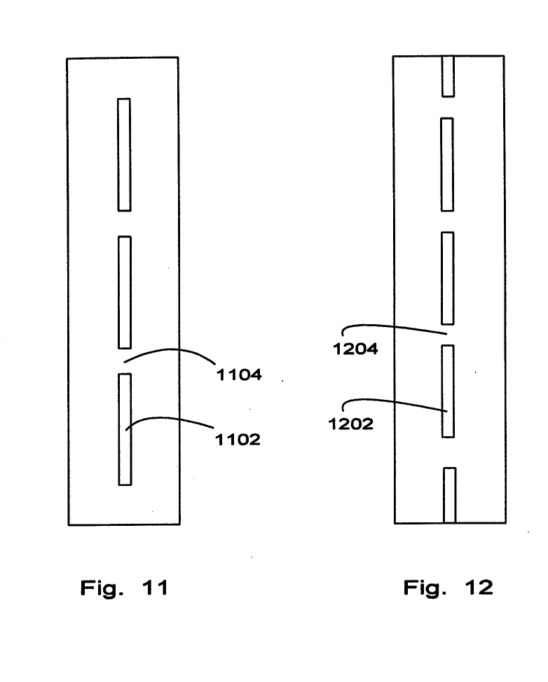

FIG. 11 is a cross sectional side view of a chamber showing the passages and supportive sections of an exemplary rigid embodiment. Also, FIG. 12 is a cross sectional side view of a chamber showing the passages and supportive sections of an exemplary rigid embodiment. Passages 1102, 1202 may be interspersed with supportive sections 1104, 1204.

The sizes and shapes of the panels and their constituent chambers in the drawings and mentioned herein may be exemplary. The panels may comprise any combination of numbers and sizes of chambers which result in the desired width, length and depth of the panels. All of the interconnected chambers of a given panel may be evacuated from a single evacuation port, non-connected chambers may be evacuated by means of the process of construction, during manufacture, or individually after manufacture.

The present invention insulation panels of the exemplary rigid embodiments discussed may comprise a series of linearly-interconnected, elongated, single-walled chambers. There may be open passages between each adjacent chamber of embodiments having connections, thereby all of the chambers may be interconnected and may be evacuated to form a vacuum space. Ideally the chambers will be of sufficient wall thickness and strength, and of any geometric shape that enable the chambers to resist collapse, such that neither a given chamber, nor the insulation panel as a whole, will collapse upon itself when a vacuum is applied. The geometric shape of the chambers may not be complete because through the lengthwise dimension, where adjacent chamber walls would coincide if the geometric shapes were complete, there may be mostly, or as would be ideal, entirely empty space. Ideally, between the sealed ends of the panel, the relatively small space between adjacent chambers may be completely open. If however, it is determined that the chambers, or the panel as a whole, can not be made to not collapse upon themselves, there may be, at intervals, within the lengthwise dimension of the panels, sections wherein the geometric shape of the chambers is complete. Stated differently, there may be, at intervals, sections wherein the front and back of the panel may be joined for support. These supportive sections, if any are needed, would form a continuous connection from the front surface of the panel to the back surface of the panel through which heat may be transferred by conduction. Therefore, if supportive sections are used, they should be as few as possible, and comprise the smallest functional percentage of the lengthwise distance from top to bottom, and function to prevent the chambers, and the panel as a whole, from collapsing upon themselves when a vacuum is applied. Therefore, unlike prior art panels, a second or separate supportive core material is not used.

Generally rigid embodiments of the present invention insulation panels:
will not collapse upon themselves—therefore no supportive core material may be needed, and therefore there may be no core material outgassing problem;
may be made of metal or glass, but could possibly be made of another suitable material, but are in any case made of a material such as a type of metal or a type of glass, for example, that does not outgas significantly—therefore getters and/or desiccants may not be needed;
if made of metal, may reflect infrared radiation, —metal, glass, or encapsulating materials etc., may comprise separate reflective coatings or materials;
may be made of metal or glass, but could possibly be made of another suitable material, but are in any case made of a material such as a type of metal or a type of glass for example, that may be successfully sealed such that they may retain a vacuum indefinitely, or “permanently”—therefore leaking seams should not be a problem;
may be completely encapsulated, in a protective, rigid, or semi-rigid, conventional insulation material such as, for example, moisture-proof closed-cell polystyrene, polyisocyanurate, or polyurethane—therefore, even if made of a type of glass, fragility should not be a problem; and
will retain an acceptably high thermal R value “permanently” or at least for an acceptably long enough period of time in order to be suitable for use in buildings—therefore decrease of thermal R value to an unacceptably low level after a reasonably long period of time should not be a problem.

In variations, the insulation panel may be made with two walls instead of one wall, and a vacuum applied between the two walls of the double-walled device.

In variations, present invention insulation panels may be manufactured including chambers of complete geometric shapes wherein the chambers that constitute the panel may be not interconnected by open passages between adjacent chambers. In this variation, each chamber may be evacuated individually thereby forming a separate vacuum in each chamber. In this variation, the chambers may be physically connected to adjacent chambers by closed shared walls.

In variations, each chamber may have a seal/cap. In variations, multiple chambers may be sealed/capped by a one-piece seal/cap.

In variations, evacuation ports may be located on the side of the chambers or located on the seal/cap.

In variations, all of a panel's chambers' shared walls may comprise passage to adjacent chambers except that selected shared walls may be closed throughout their entire length with no passage. Such a panel may thereby be divided into two or more groups of chambers, the groups being interconnected by passages. Each group of interconnected chambers may be evacuated by a single evacuation port. In this variation, should vacuum be lost in a given group of interconnected chambers, the remainder of the groups of interconnected chambers may continue to function appropriately.

Much of the generalized information in the above description of the exemplary embodiments and variations generally describing rigid chambers, is applicable to other embodiments of the invention, such as embodiments including non-rigid panel precursors for example. All such information however, is not repeated redundantly in the description of each embodiment.

Following is information generally regarding embodiments and/or variations using non-rigid panel precursors.

It may be beneficial to the reader in understanding this disclosure to visually perceive an exemplary vacuum insulation panel produced from a non-rigid panel precursor. An exemplary insulation panel may be perceived as being for example 8′ tall, 13.25″ wide, 0.25″ to 1.0″ deep, and constructed of material, for example an aluminum alloy, for example 0.001″ to 0.005″ thick. The dimensions may be lesser or greater. In any case, the material may be relatively thin and comprise a minimal quantity of total mass and thereby conduct a minimal amount of heat from a first wall of a vacuum insulation panel to a second wall of a vacuum insulation panel. If encapsulated in exemplary 0.75″ thick closed-cell polystyrene or other encapsulating insulating material, the total depth or thickness of the encapsulated vacuum insulation panel may be approximately, 1.75″ to 2.5″ for example. If installed along the outer or exterior of a wall space of “2×6” framing for example, approximately 3.0″ to 3.75″ of wall depth space remains available immediately “behind” the interior finished wall material for other uses such as are discussed elsewhere in this writing. Exemplary “2×8” or “2×10” framing of course provide more available wall depth space available after installation of present invention vacuum insulation panels. This may be seen for example in FIG. 13.

All information provided in this disclosure regarding any embodiment and/or any variation and/or any combination thereof may be considered to be potentially applicable to all of the embodiments and/or variations and/or combinations thereof.

FIG. 13 is a cross-sectional view of wall (not to scale) showing placement of one embodiment of the invention in reference to electrical conduits or wires 1302, electrical boxes 1304, exterior siding 1306, interior finished wall material 1308, conventional materials/space 1313, and top and bottom wall framing 1315. The encapsulating insulation material 1314 has insulation panel 1312 disposed therein.

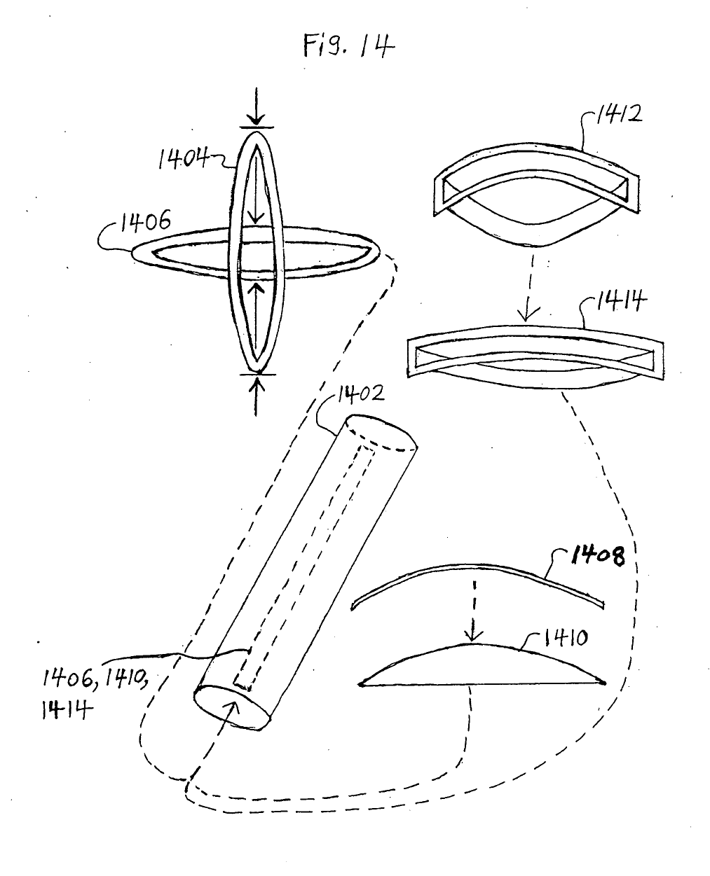

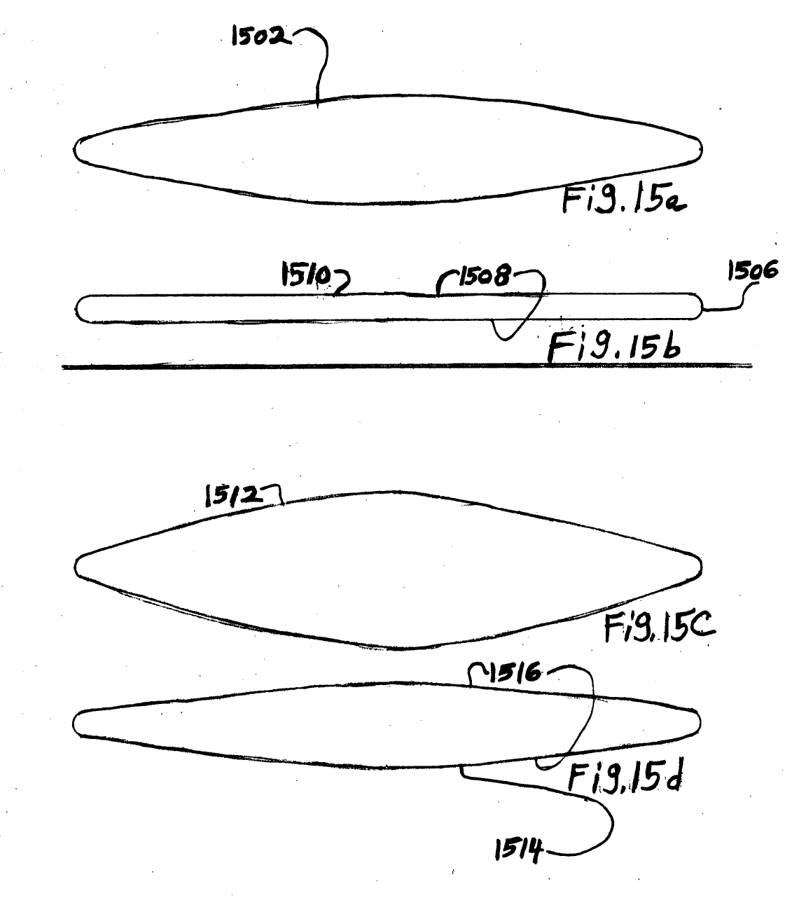

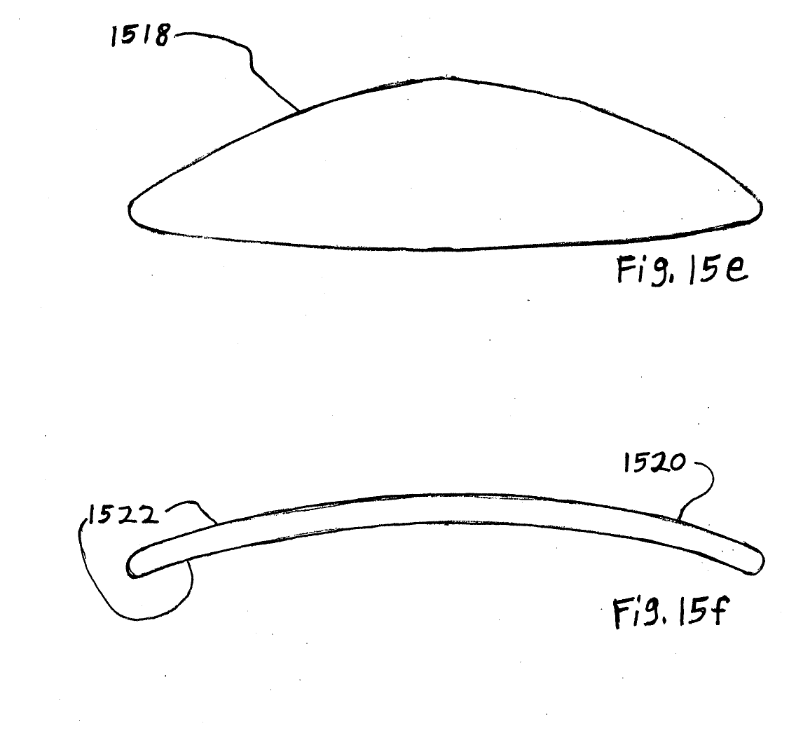

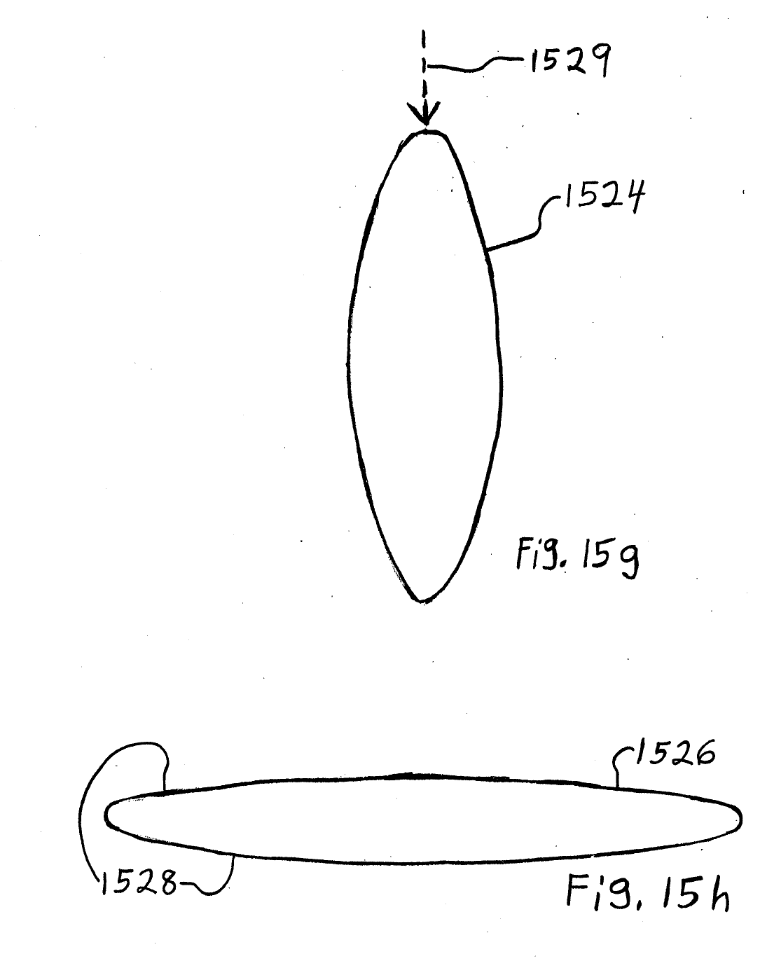

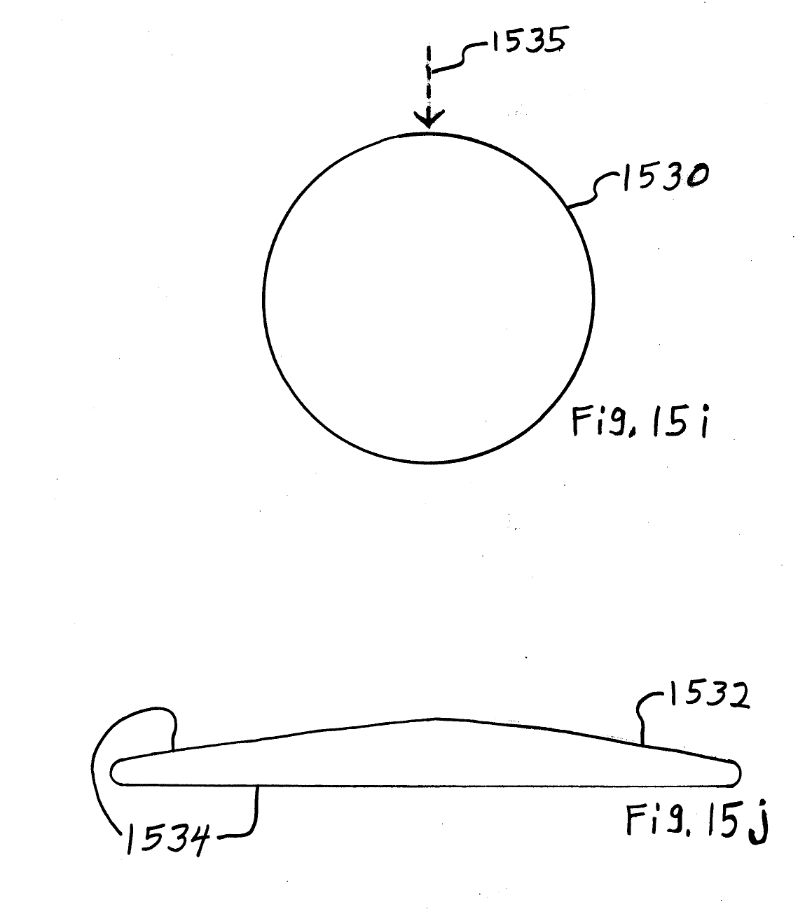

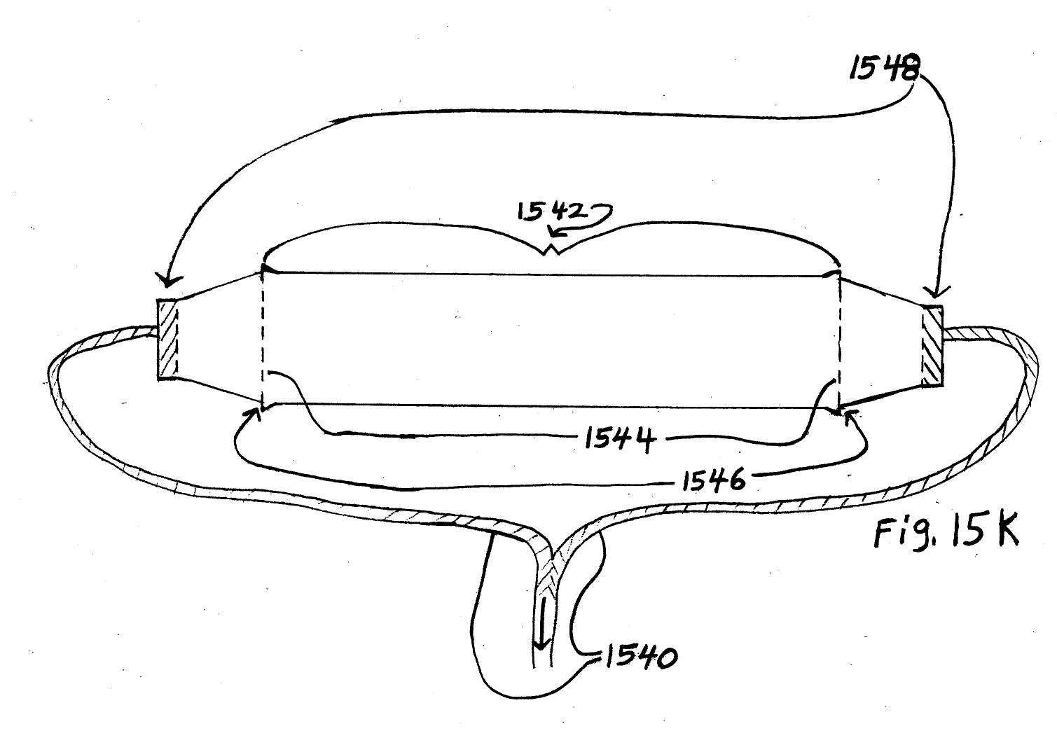

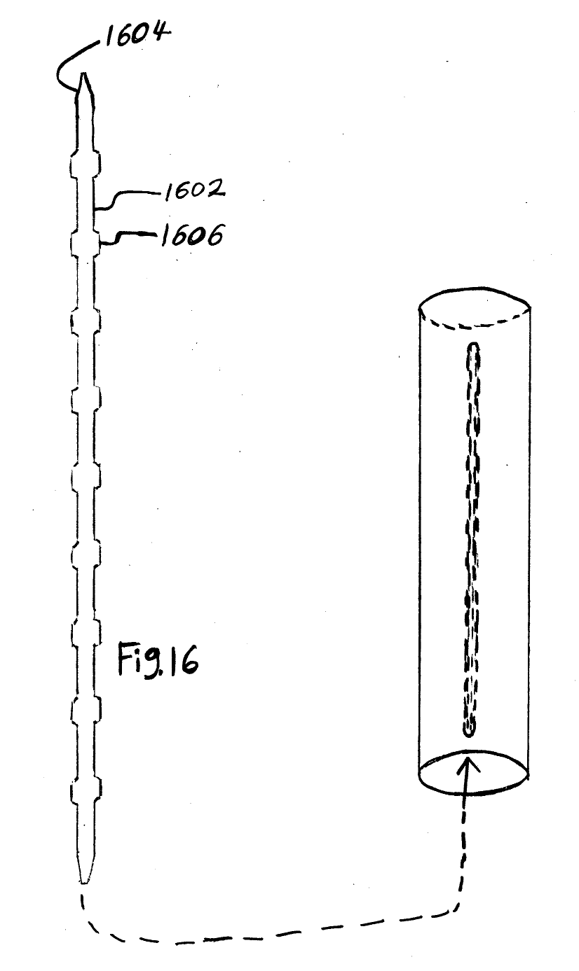

FIG. 14 is a perspective view of an embodiment of the invention in the non-rigid “panel precursor” stage of manufacture. The non-rigid panel precursor 1402 may be produced by extrusion or by any other method. Optionally, if it would make manufacturing easier, the panel precursor may for example, firstly be produced to be cylindrically round, then for example, secondly be processed by being passed through a set of rollers for example, thereby being transformed into a desired cross-sectional shape exemplified in FIGS. 15a, 15c, 15e. and 15g. In some embodiments, optional adjustable elliptical vertically-oriented pressure-exerting band pre-compression 1404 may be temporarily compressed to become horizontally-oriented elliptical pressure-exerting band 1406, then inserted into the panel precursor, then its pressure released. An alternatively-designed optional convexo-concave adjustable pressure-exerting band 1408 is shown “closed”. The alternatively-designed adjustable pressure-exerting band 1410 is shown in its half-moon shape when it is “open” or “released”. Either of the two types of optional bands may be inserted into a panel precursor and assist in accomplishing two basic goals. Firstly its adjustable pressure may assist in giving the evacuated insulation panel its desired final size and shape and assist in permanently retaining that size and shape. Secondly it may assist in preventing bending or buckling etc. The optional adjustable pressure-exerting band and the alternatively-designed optional half moon-shaped adjustable pressure-exerting band are discussed in greater detail elsewhere in this writing. FIG. 15a and FIG. 15b are a pair of cross-sectional end views of one embodiment of the invention respectively prior to evacuation and after evacuation during manufacture. Non-rigid panel precursor and pre-evacuation interior space 1502 have an elliptical cross-section (also seen in 1402).

The non-rigid panel precursor exemplified in FIG. 14 for example, may be manufactured with open ends, then have the ends sealed so that it may be evacuated. Alternatively, in some embodiments the ends may be sealed as a part of the process of producing the non-rigid panel precursor, by a process of extrusion for example. The relatively small radius at collapse-resistant side edge 1506 resists the external force of atmospheric pressure and the “force” of the internal vacuum and resists collapse during and after evacuation. After evacuation, generally rectilinear first and second walls 1508 result, defining an insulation panel and evacuated interior space 1510 of markedly different shape than panel precursor and pre-evacuation interior space 1502.

In an alternatively-shaped embodiment exemplified in FIG. 15c and FIG. 15d, an alternatively-shaped non-rigid panel precursor 1512 with a cross-sectional shape with greater convexity than in other embodiments may be used. The convexity of the walls, rigidity of the material, and thickness of the material, etc. of the panel precursor may be coordinated with the measure of the manufacturer's lowest achievable internal pressure at the end of the evacuation process to produce an alternatively-shaped evacuated insulation panel 1514 with both walls somewhat convexly curved from side to side, i.e. with a somewhat elliptical cross section in contrast to the generally rectilinear walls of other embodiments. The strength, support, and resistance to buckling, etc. provided by an appropriate measure of side-to-side convexity and a somewhat elliptically-shaped cross section of both walls 1516 of the evacuated insulation panel may completely eliminate any need for an optional adjustable pressure-exerting band. It may also eliminate the need for any type of optional center support component whatsoever. In a second alternatively-shaped embodiment exemplified in FIG. 15e and FIG. 15f, non-rigid panel precursor 1518 may have a cross section with convexly-curved collapse-resistant side edges, one wall that is either rectilinear or else has a relatively small amount of convexivity, and one wall that has a relatively great amount of convexivity. The evacuated insulation panel 1520 may in this case have a cross section with convexly curved collapse-resistant side edges, one convex wall, and one concave wall. In this case the second alternatively shaped first and second walls 1522 and the cross section of the evacuated insulation panel may be described as being convexo-concave. Some panel precursors may be evacuated easiest by the “punctured hole” method, and others may be evacuated easiest with adaptor(s) placed over open end(s) described elsewhere in this writing. A goal and an advantage of the embodiments depicted in FIGS. 15c, d, e, f, g, h, i, and j may be to eliminate the need for an optional adjustable pressure-exerting band. Another goal and advantage may also be to eliminate the need for an optional rod-shaped spacer/center support component, or any other form of center support component. Potential heat conduction via an optional rod-shaped spacer/center support component or any other form of center support component simultaneously in direct contact with first and second walls of the evacuated insulation panel may thereby be eliminated and the embodiments of FIGS. 15c, d, e, f, g, h, I, and j may be the simplest embodiments presently contemplated. The evacuated insulation panel may be then encapsulated and may be in direct contact only with the encapsulating insulation material and/or an air space inside of the encapsulating insulation material.

As is discussed elsewhere in this writing, if the walls of the panel precursor tend to collapse together too completely, one of several options available is to increase the convexivity of the cross-section of the panel precursor. FIGS. 15g,h,i,j, and k address this option more fully. Panel precursors 1524 and 1530 have more vertical convexivity than other exemplary panel precursors and may use a machine to exert downward pressure 1529, 1535 onto the top of the panel precursor at the beginning of the evacuation process and continue to exert pressure for an appropriate duration of time during the evacuation. The downward pressure may cause the controlled partial implosion or controlled partial collapse to occur through the vertical dimension of the panel precursor whereas without the pressure it would naturally occur through the horizontal dimension. The pressure may be discontinued at an appropriate point of the evacuation process once the vertically-oriented direction of contraction of the walls has been established. A goal and an advantage of using a panel precursor with a maximal measure of vertical convexivity such as exemplified if FIG. 15g is to produce an evacuated insulation panel with first and second walls with a maximal amount of outwardly-directed force derived from resilience and an inertial tendency to retain or return to the shape of the maximally vertically convex panel precursor 1524. In this example the geometric change in shape from panel precursor to evacuated insulation panel is maximal. Evacuated insulation panels 1526, 1532 may result with first and second walls of exemplary shapes 1528, 1534. A significant, pre-determined and “adjustable” degree of resilience and inertial tendency of the first and second walls of the evacuated insulation panel to retain or return to the shape of the panel precursor may remain in the first and second walls of the evacuated insulation panel and contribute significantly to counter the “force” of the internal vacuum and the force of atmospheric pressure, thereby producing and permanently maintaining the evacuated panel in its desired size and shape. This may allow for the material used to be desirably thin and for the completeness of the vacuum to be desirably great. This may also eliminate a need for any optional adjustable pressure-exerting band and a need for any center support component.

The shape of the part of a machine that may contact a panel precursor to apply downward pressure 1529, 1535 and/or the shape of a platform on which a panel precursor may lie during manufacturing may be configured to influence the final shape of the evacuated panel. A machine may exert pressure downwardly and/or upwardly.

The reason, in embodiments with relatively great vertically-oriented convexivity for example, for exertion of downward pressure throughout an appropriate length of the lengthwise dimension of the center section of the panel precursor is to direct the controlled partial implosion or controlled partial collapse through the vertical, not the horizontal dimension of said panel precursor. A reason, in many embodiments, for exertion of downward, or downward and upward pressure widthwise at locations to be sealed, may be in some cases, if it is determined to be necessary, to loosely crimp the first and second walls together for the purpose of restraining an optional adjustable pressure-exerting band in its desired position until the evacuation is completed at which time it is permanently frictionally restrained in its desired position. It could also restrain an optional center support component in its desired position until the evacuation is completed. A loosely crimped widthwise portion will not impede air flow during evacuation. Another reason is to crimp the walls together so they be permanently sealed.

FIG. 15k exemplifies panel precursor of a cross-sectional shape as exemplified by FIG. 15g and/or FIG. 15i at the conclusion of the evacuation. Note that the width of the evacuated center section is of greater width than that of the open ends 1548 which are shown in FIG. 15g and FIG. 15i. Optionally, temporary reusable size and shape retainers may be used in the open ends 1548 during evacuation. More optional or alternative methods, materials, and sequence of manufacturing steps etc. potentially applicable to other embodiments are herein exemplified. If needed, an optional adjustable pressure-exerting band may be installed, or if needed, an optional center support component may be installed. If other embodiments, methods, and materials are used, one or more ends of the panel precursor may be sealed prior to evacuation, but in the embodiment exemplified in FIG. 15k, neither end is sealed until the conclusion of the evacuation process, while the pump(s) continue(s) to run. This may be because the great extent of vertical convexivity of FIGS. 15g and 15i may make crimping the first and second walls of the panel precursor together in order to seal them difficult. The part of a machine that contacts the top of a panel precursor and applies downward pressure on it may extend throughout the longitudinal length 1542 and may also extend widthwise across the panel precursor at and/or near each end of the length 1542 where the material will be crimped together and sealed at the conclusion of the evacuation process while the pump(s) continue(s) to run. In this example, downward pressure exerted widthwise at the locations to be sealed, along with an appropriately-designed platform on which the panel precursor may lie, or else both upwardly and downwardly-exerted pressure at the locations to be sealed may be advantageous in bringing first and second walls in contact with each other so they may be sealed. Using both ends for evacuation and not sealing any ends until the conclusion of the evacuation process may be a desirable option regarding several embodiments of the present invention. Both open ends are used simultaneously by two adaptors and a bifurcated hose 1540 to effect the evacuation. Downward pressure may be applied throughout the length 1542 at the beginning, and for an appropriate duration of the evacuation process. Both sealed ends 1544 may sealed at the conclusion of the evacuation process while the pump(s) continue(s) to run. Then the panel may be severed at both severing locations 1546, and then encapsulated in encapsulating insulation material.

It may be beneficial to the reader in understanding many of the generally non-rigid embodiments to review the following abbreviated, simplified list of exemplary items that represent some of the many options and alternatives that may be available to the manufacturer. It must be understood that the sequence in the steps of manufacturing is essential.
Physical characteristics of material such as malleability, resilience, inertia, rigidity, thickness, and convexivity
Completeness of vacuum, i.e. ratio of low internal pressure to atmospheric pressure
Desired final shape of evacuated insulation panel
Seal prior to evacuation or seal at conclusion of evacuation while pump continues to run
Optional adjustable pressure-exerting band
Optional center support component
Optional temporary size & shape retainer
Evacuate through one or both open ends, or through punctured hole
Lengthwise downward pressure
Widthwise downward, or downward and upward pressure at location for loosely crimping together, or for crimping together and then sealing
(In some embodiments—evacuation port component or permanent barrier/flange/evacuation port, etc.)

A suitable material of which to construct a generally non-rigid panel precursor of the present invention insulation panel may be a metal or alloy, an alloy of aluminum for example, which may have an ideal measure of characteristics that may be pertinent and desired by the manufacturer such as for example, ductility, malleability, elasticity, resilience, rigidity, reflectivity, etc. The content and physical properties of the material should be relatively consistent in order to assure smooth and consistent manufacture. Size, shape, geometry, wall thickness, metallurgical characteristics etc., of the panel precursors should be relatively consistent for all panel precursors or at least all panel precursors in a given stockpile of panel precursors. The material may consist at least partially of recycled material, and may itself in turn be recycled.

Production of some embodiments of the insulation panel may be begun by producing a non-rigid panel precursor by continuous extrusion or by any other method, for example 6″ to 2′ longer than the final product, the insulation panel, will be.

Seamless non-rigid panel precursors may be produced by continuous extrusion and then cut to length. Panel precursors may also be produced in a mold, a vertically-oriented mold for example, or with sheet metal or skelp and a mandrel, or by any other method. Seamless extrusion may be an advantageous method potentially simplifying the transformation of a non-rigid panel precursor into an evacuated insulation panel. Optionally, panel precursors may be firstly manufactured as being cylindrically round, then secondly transformed to a desired cross-sectional shape as exemplified in FIGS. 15a, 15c, 15e, and 15g, for example, by for example being passed through rollers.

By what ever method they are produced, it may be easy to produce non-rigid panel precursors in a variety of lengths and widths. Production by extrusion may be advantageous.

If needed, as shown in FIG. 14, an optional adjustable pressure-exerting band 1404, 1406, such as a convexly-curved component similar in function to leaf springs may be used. The exemplary “spring loaded” component may be for example, approximately 0.002″ to 0.010″ thick and 0.5″ to 2.0″ wide, though the dimensions may be lesser or greater. It, like the panel precursor and the evacuated insulation panel, comprises a minimal quantity of total mass. It may be in the form of a continuous band having a convexivity greater than that of the inner surface of the walls of both the panel precursor and the evacuated insulation panel. The amount of potential energy that the band possesses and the amount of pressure it exerts onto the inner surfaces of the walls of the evacuated insulation panel may be adjusted by adjusting the thickness, pre-compression convexivity, and metallurgic content and physical properties etc. It may be produced simply by cutting a strip of material from a sheet of material, the same type of material, for example, of which the panel precursor is made, for example an alloy of aluminum that does not outgass significantly. Alternatively, it may be made of a different metal or alloy or material with a desirable measure of strength, stiffness, resilience, etc. The two ends of the long strip may be overlapped and welded together, thereby a continuous band is formed. The band may then be forced into the shape of for example a circle, long vertically-oriented ellipse, or long horizontally-oriented ellipse. Then it may be compressed, inserted inside of the panel precursor, then its pressure released onto the interior surface of the first and second walls. Maximal pressure may be achieved by compressing a substantially elongated elliptical component through its long length, then friction fitting it into the panel precursor. Minimal pressure may be achieved by compressing a substantially elongated elliptical component through its short length, then friction fitting it into the panel precursor. A medium amount of pressure may be achieved by compressing a round component and friction fitting it into the panel precursor. It may be friction fit inside of the panel precursor at the widthwise center point and extend in the lengthwise dimension of the panel precursor from relatively near the location where the first sealed end will be to relatively near the location where the last sealed end will be. It may extend near, but not into the area of the panel precursor where sealing will take place. Therefore it will not interfere with sealing, punctured holes, adaptors, temporarily-inserted spacers or shape retainers, or any component or procedure of the manufacturing, evacuation, or sealing process. The installed component has substantially the same shape as the interior surface of the walls. It basically constitutes, in effect, a strip of additional wall material having the function of exerting pressure against the interior surface of the walls. There is no direct contact of the portion of the component that is pressing against a first wall and the portion of the component that is pressing against a second wall within the lengthwise dimension of the panel precursor—there is vacuum space between the two. No direct path of heat conduction is formed through the large area of the empty vacuum space of the panel precursor. The hollow evacuated void interior of the panel is not interrupted. Such a “spring loaded” band may provide strategically-located support throughout the lengthwise dimension of the insulation panel where it may be needed the most, that being at the widthwise center point of the insulation panel, half way between the convexly-curved side edges which are resistant to collapse. Furthermore, such a “spring loaded” band may naturally exert its maximal amount of pressure at its lengthwise center point which is also the lengthwise center point of the panel precursor—again, where the pressure may be needed the most. One of its advantages may be that it may be permanently held in place by virtue of its relatively wide with, approximately 0.5″ to 2.0″ for example, and by simple friction. Another advantage may be that it does not form a continuous path of heat conduction through the large area of the empty vacuum space. The adjustable pressure exerted by the band may compliment the strength and convexivity of the panel precursor walls and the inertial tendency of the walls of the evacuated insulation panel to retain or return to the greater convexivity of the panel precursor, the goal of these outwardly-exerting forces being that of counteracting the inwardly-exerting “force” of the internal vacuum and the force of atmospheric pressure to achieve equilibrium and permanently maintain the desired shape of the walls of the evacuated insulation panel and permanently maintain the desired distance between the walls and the vacuum therein.

Alternatively, as shown in FIG. 14, an alternatively-designed optional half moon-shaped adjustable pressure-exerting band 1408, 1410 may be manufactured in the form of a convexo-concave spring-loaded device possessing potential energy. Two strips of relatively stiff metal, one longer than the other, are attached at their ends. They form a convexo-concave component. Pressure may be applied at the longitudinal center point of the convexly-curved surface while the ends are not allowed to move—its shape and potential energy are thereby “snapped” or transformed into a half moon-shaped component with one rectilinear surface and one convexly-curved surface. It is likely that this alternatively-designed optional adjustable pressure-exerting band may be inserted inside of the panel precursor either “closed” or “released”, if inserted “closed”, it will need to be “released” once it is inserted. The half moon-shaped device may exert an “adjustable” or a pre-determined amount of pressure onto the interior walls of the panel precursor and the insulation panel. As an example, a convexo-concave shaped band that would be open or be “released” or “snapped” into a generally half-moon shape with a depth of 2.5″ if it were unobstructed, may be inserted into a panel precursor which, after evacuation may produce an insulation panel with a depth of only 0.75″ for example, the band thereby exerting outwardly-directed pressure. It may comprise a minimal quantity of total mass, it friction-fits on the interior surface of the walls of the insulation panel, and it does not form a continuous path of heat conduction through the large area of the empty vacuum space. It is likely that the maximally-achievable amount of force available from this half moon-shaped band may be greater than the maximally-achievable amount of force available from the previously-described optional adjustable pressure-exerting band. It is likely that the amount of force potentially available from an appropriately designed, sized, and shaped half-moon shaped band may be able to satisfy any requirements for outwardly-directed pressure exertion. The amount of outwardly-directed pressure exertion that could potentially be exerted by such a band may in fact exceed the requirements of any embodiment of the present invention. Therefore it may be likely that enough outwardly-directed pressure may be available for the present invention to comprise a manufacturer's lowest reasonably-achievable internal pressure. Stated differently, it may be likely that enough outwardly-directed pressure may be available to the present invention such that outwardly-directed pressure may not be a limiting factor in the goal of using minimally thick material comprising a minimal amount of total mass, and using the manufacturer's most reasonably complete vacuum, thereby maximizing the thermal R value of the present invention. If a reasonably small measure of asymmetry of the shape of the insulation panel results, it is of no consequence—the insulation panel will still fit inside of its encapsulating insulation material.

A second type of an alternatively-designed convexo-concave shaped pressure-exerting band similar to 1408 may comprise a wide center metal strip with a narrow metal strip on both sides of it. In 1408 the two strips of metal are connected at each end, similarly, this second type of an alternatively-designed convexo-concave shaped pressure exerting band has all three strips of metal connected, side-by-side at each end. When it is open or “released,” or “snapped,” the center strip may protrude downwardly while the two side strips may protrude upwardly. The resulting shape therefore is not half-moon shaped with one generally rectilinear portion as may generally be the case in 1410, but is instead generally elliptical much like 1406. Thereby the pressure exerted on the first and second walls may be more equal and symmetrical than may be the case with a half-moon shape.

One difference between the two general types of pressure-exerting bands herein exemplified is that, for example, 1404, 1406 consists of a continuous loop of metal whereas for example, 1408, 1410 and the above described second alternatively-shaped band consist of strips of metal connected at each end. Other designs of optional adjustable pressure-exerting bands are contemplated.

Either of the two types of optional bands 1406, 1410 may assist in accomplishing two basic goals. Firstly its adjustable pressure may assist in giving the evacuated insulation panel its desired final size and shape and assist in permanently retaining that desired size and shape. Secondly it may assist in preventing bending or buckling etc., at the time of the evacuation and manufacturing, shipping, installation in a building, and permanently thereafter.

Alternatively, one or more optional adjustable pressure-exerting bands may be placed and oriented to extend through the widthwise dimension of the panel precursor instead of extending through the lengthwise dimension.

Alternatively, if additional pressure is needed, one or more coil springs may be attached to both interior surfaces of the band, then the springs compressed and the band inserted and the pressure released.

Exemplary optional center support component 1602 of FIG. 16 may be a generally rod-like body having flattened sections such as flattened section 1606. It may further optionally have tapered end 1604 to provide a better fit to embodiments of the panel which have a tapered interior space at the sealed ends, however, such details are not inflexible. It may be installed inside of a panel precursor at the widthwise center point and may extend generally from the first sealed end to the last sealed end, as may be seen in FIG. 16. It may function to arrest the movement of the first and second walls toward each other at the conclusion of the evacuation process and to assist in preventing buckling and to permanently maintain the desired distance between the two walls of the evacuated panel precursor. Alternatively, it may be a hollow perforated tube, or a ridge of material that is not a separate component, but rather is a part of the panel precursor material.

If needed, an optional center support component or system may be used to assist in arresting the movement of the first and second walls toward each other at the conclusion of the evacuation, and/or for other purposes such as strength and support to assist in keeping the first and second walls apart during manufacturing, transportation, and installation, and maintaining the empty space between first and second walls of the evacuated insulation panel, permanently keeping the two walls apart after installation. However, it may be likely that a type of optional adjustable pressure-exerting band may perform these functions and may have advantages over an optional center support component.

An optional center support component for example, (1) a rod-shaped spacer with passageways, (2) a hollow perforated tube, (3) a mass of metal in the form of steel wool or silica (4) coil springs, (5) elongated coil springs, or (6) a ridge of material, not a separate component, but a part of the panel precursor material, for example may be used inside of a panel precursor and insulation panel. These optional components may function to assist in arresting the movement of the two walls toward each other at the conclusion of the evacuation and to prevent buckling and assist in permanently maintaining the desired distance between the two walls of the evacuated insulation panel. Coil springs or elongated coil springs may provide the additional function of exerting an adjustable amount of pressure against the interior surface of the walls similarly as is discussed elsewhere in this writing regarding optional adjustable pressure-exerting bands—however, an optional center support component may form a direct path of heat conduction through the otherwise large empty area of the vacuum space from a first wall to a second wall of the insulation panel, though the conduction thereof may be minimal. Again, if needed, an optional adjustable pressure-exerting band may be preferable to an optional center support component because for example, it is likely that an optional adjustable pressure-exerting band may stay in place during manufacturing by virtue of its width and simple friction whereas a center support component may need to be secured in place by other means. Also, again, an optional adjustable pressure-exerting band leaves the large area of vacuum space empty.

Alternatively, yet another exemplary type of an optional center support component, or system may be contemplated. This alternative of an exemplary center support component or system may comprise a pair of magnets or magnetized components attached to the outside of the walls of the panel precursor and the evacuated insulation panel and located in opposition to each other, their repulsion across the vacuum space assisting in permanently keeping the two walls apart. Such magnets may be attached to the outside of the walls by aluminum tape, for example.

If an optional center support component is needed, it, similar to the panel precursor and the evacuated insulation panel, may advantageously comprise a minimal quantity of total mass. Some exemplary center support components may be manufactured separately, or may be manufactured as a constituent part of a panel precursor. Any center support component used on the inside of an insulation panel may advantageously be made of the same type of material as that of the panel precursor and the insulation panel, but in any case may be made of a material that does not outgass significantly.

The encapsulating insulation in which a vacuum panel is encapsulated may reduce the amount of heat that reaches the insulation panel and may therefore also minimize the amount of heat that reaches any optional center support component.

Encapsulating insulation material may prevent the insulation panel from bending by enveloping and supporting the panel from outside of the panel walls.

If the relatively long longitudinal length of the present invention is found to cause manufacturing difficulties, an alternative may be, for example, to manufacture two nominally 4′ panels and encapsulate them in one nominally 8′ encapsulating unit. Another alternative may be to manufacture nominally 4′ panels and nominally 4′ encapsulating units and, in a typical wall cavity for example, install the two nominally 4′ units one above the other. Several standard sizes and combinations thereof may be produced to maximize the percentage of a building that may be fit with encapsulated vacuum insulation panels.

Generally, in embodiments using non-rigid panel precursors, when sealing the first and second walls of the panel precursor and/or evacuated insulation panel, the first and second walls are crimped together in direct contact with each other at the location where they are to be sealed. Then, an appropriate method of sealing exemplified in the terminology section of this writing may be used. Any excess material at the sealed part of an evacuated insulation panel may be trimmed off so as to minimize the quantity of total mass.

Generally, in embodiments using non-rigid panel precursors, the sequential order in which the steps of manufacturing take place may vary from one embodiment to another.

Generally, in some embodiments, if an optional adjustable pressure-exerting band (or optional center support component) is used, it may be installed, then the first and/or second walls may be crimped together and sealed, or may be “loosely” crimped together but not sealed. Whereas it may be determined not to be necessary, “loosely” crimping together but not sealing the material at locations that are to be sealed may be advantageous for securing an optional adjustable pressure-exerting band (or optional center support component) in place during manufacturing. Such a “loosely” crimped area that is not sealed will not prevent air flow necessary for evacuation.

Any excess material at the sealed ends of an insulation panel may be trimmed off, assisting to minimize the total quantity of mass of the panel.

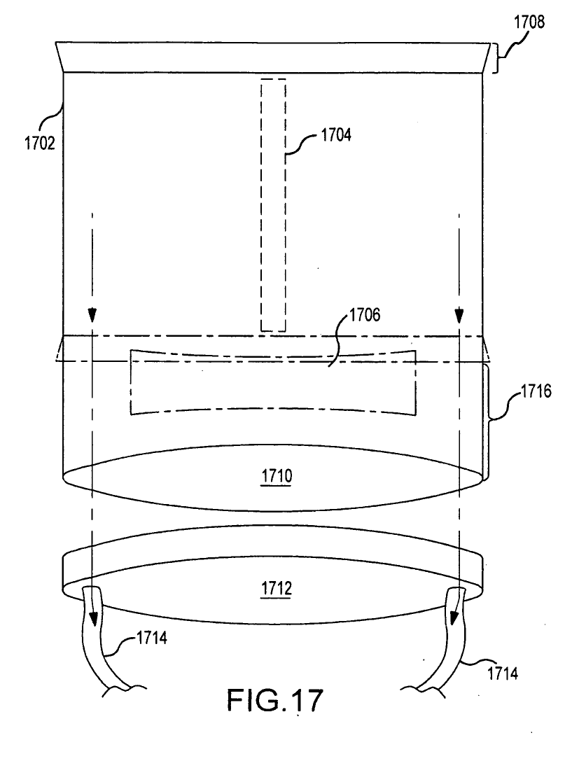

As shown in FIG. 17, if an optional adjustable pressure-exerting band is used, or if an optional center support component is used, after it is installed, the first end of the non-rigid panel precursor may be sealed. Then, a flexible, elastic, resilient adaptor seamlessly including one or two evacuation hoses may be placed over the open second end of the panel precursor. It may be necessary to place an elastic band or a clamp over the adaptor in order to acquire an air-tight seal.

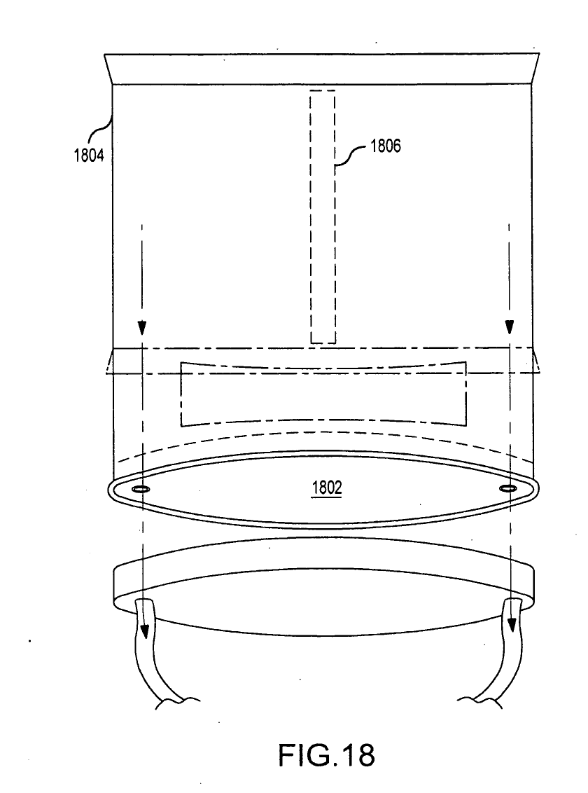

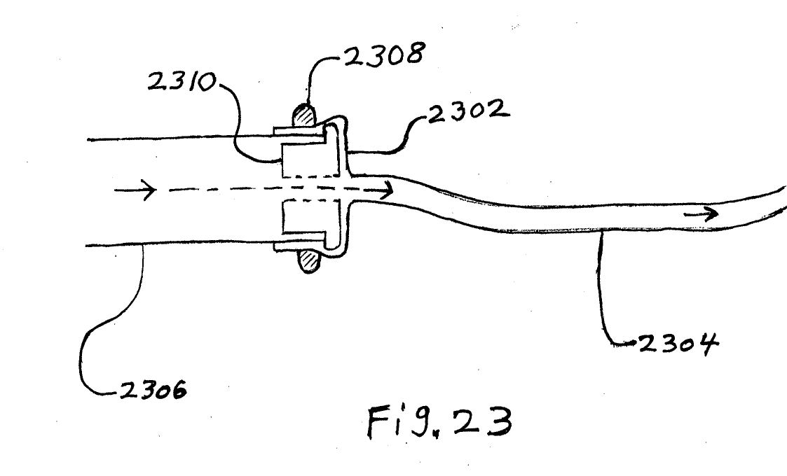

Optionally, it may be advantageous to place a temporarily-inserted, rimmed, rigid, size & shape retainer inside of the open second end of the panel precursor before placing the flexible, elastic, resilient adaptor over the open second end of the panel precursor, as seen in FIGS. 18 and 23.

FIG. 17 is a partially transparent perspective view showing details of one embodiment of the invention and construction thereof. Panel precursor 1702 has exemplary optional adjustable pressure-exerting band 1704. In some embodiments, for example, between the end of the optional adjustable pressure-exerting band 1704 and the open end 1710 an area of potential complete collapse 1706 is depicted, representing the portion of the panel precursor which may completely collapse during evacuation. This area of potential complete collapse may be inconsequential because of being located within the portion of the panel precursor which is sealed after evacuation 1718 and/or located within the excess material 1716 which may be severed and recycled after evacuation and sealing.

First end 1708 may be sealed prior to evacuation, and open second end 1710 may be used for evacuation. Evacuation adaptor 1712 having evacuation hose(s) 1714 may be placed over the open second end of the panel precursor and may form a seal over open second end 1710 while the evacuation may be carried out. At the conclusion of the evacuation process, while the evacuation pump continues to run, second seal 1718 may be sealed.

At the conclusion of the evacuation process, while the pump(s) continue to run, the panel precursor may be sealed at an appropriate distance, for example, 6″ to 1′ inward from the second end of the panel precursor, though the distance may be greater or less than that range. It may be sealed immediately distally, for example, to the end of an optional adjustable pressure-exerting band. After the sealing is accomplished, the evacuation pump(s) is/are turned off and the adaptor, elastic band, size & shape retainer, etc. are removed. Then the excess panel precursor material 1716 may be severed distally to the second seal 1718. This material which may be approximately, for example 6″ to 1′ in length may be recycled and used as material for producing additional non-rigid panel precursors.

FIG. 18 is a partially transparent perspective view showing details of an alternative embodiment and construction thereof. Rimmed size & shape retainer with opening(s) 1802 may be used within the open second end of the non-rigid panel precursor 1804 during the evacuation so that the open second end retains its size and shape, or assumes the size and shape of rimmed size & shape retainer with opening(s) 1802 during evacuation.

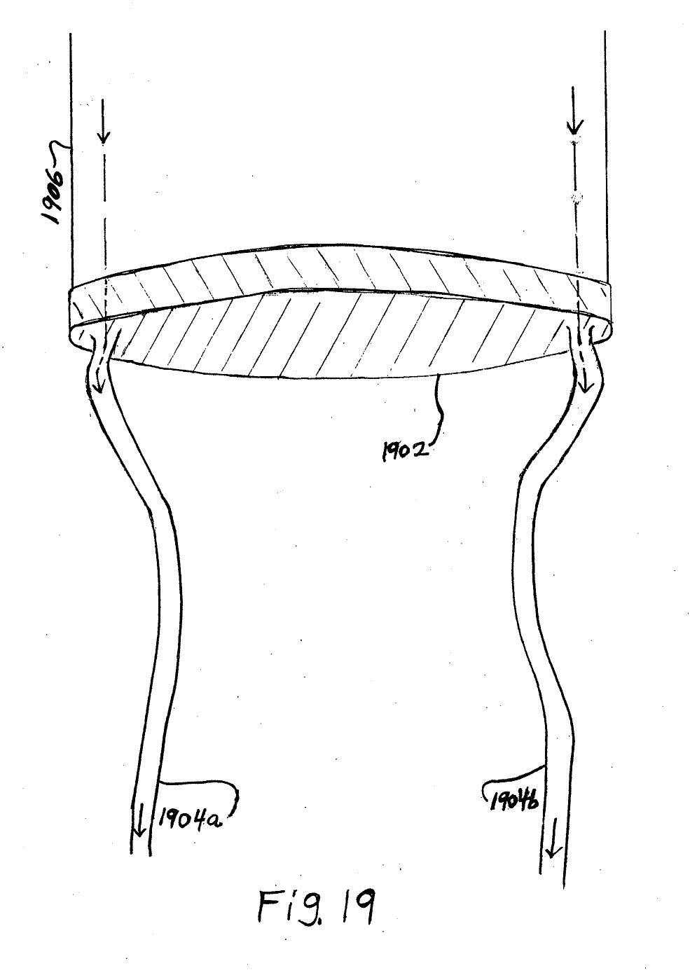

FIG. 19 is a perspective view showing details of construction techniques of one embodiment of the invention. Adaptor 1902 has two evacuation hoses 1904a, 1904b used to evacuate non-rigid panel precursor 1906.

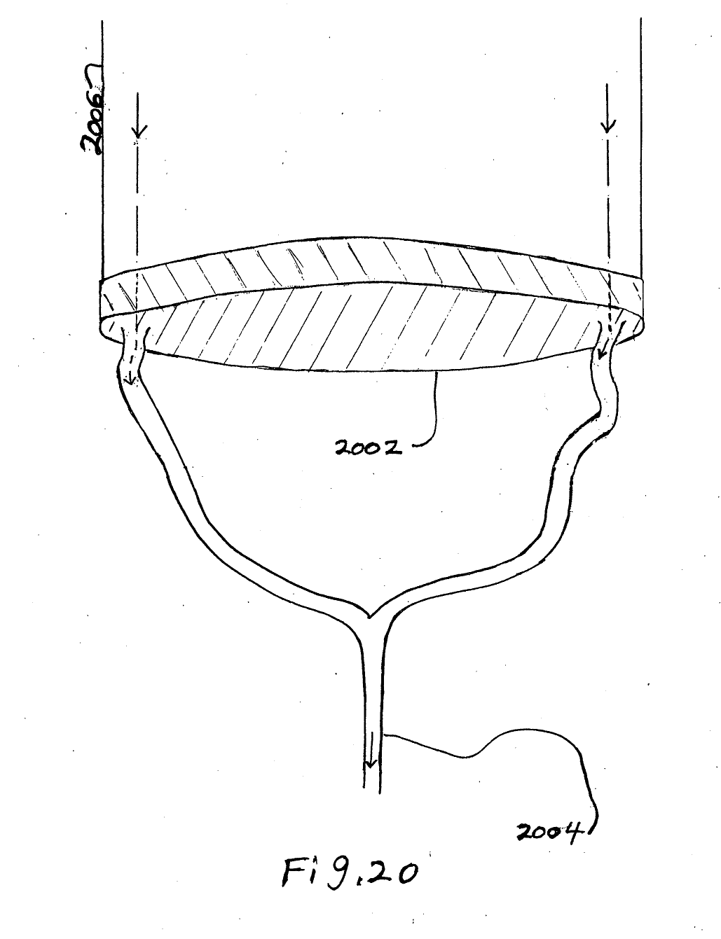

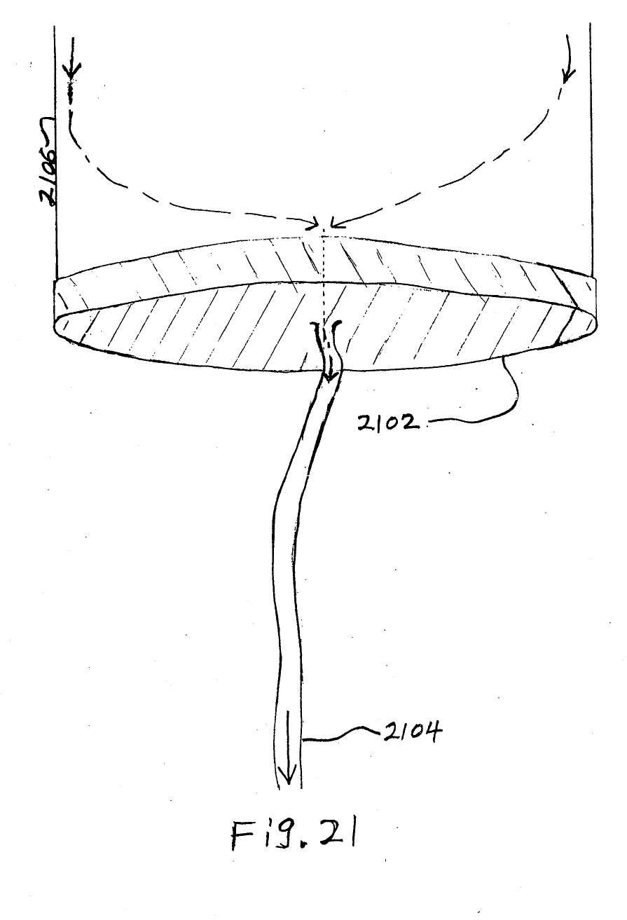

FIG. 20 is a perspective view showing details of construction techniques of one embodiment of the invention showing adaptor 2002 with bifurcated evacuation hose 2004 and non-rigid panel precursor 2006.

FIG. 21 is a perspective view showing details of construction techniques of an alternative embodiment of the invention showing adaptor 2102 with a single evacuation hose 2104, and non-rigid panel precursor 2106.

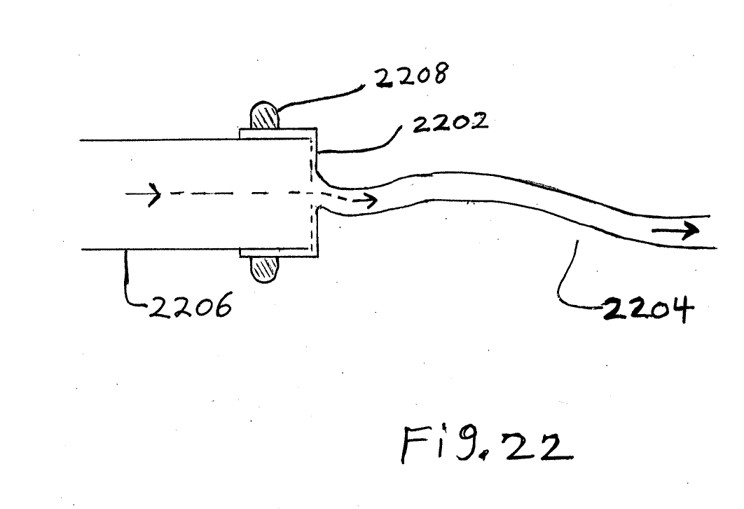

FIG. 22 is a cross-sectional side view of one alternative of one embodiment of the invention, showing details of manufacture, particularly the evacuation. Adaptor 2202 may have one or more evacuation hose(s) 2204 and may be fitted over the open second end of the non-rigid panel precursor 2206 and held in place by an elastic member 2208 which may be separate from or part of the adapter 2202.

FIG. 23 is a cross-sectional side view of one alternative of one embodiment of the invention, showing details of manufacture using an adaptor 2302 having an evacuation hose 2304. The adaptor may be fitted over the open second end of non-rigid panel precursor 2306 and may be held and/or sealed by means of elastic band 2308. This embodiment may use rimmed size & shape retainer with opening(s) 2310 so that the size and shape of the open second end may be retained during evacuation.

If rimmed size & shape retainer with opening(s) 2310 is used, when it is inserted its rim comes into contact with the perimeter of the open second end of the non-rigid panel precursor. The rimmed size & shape retainer may have openings the locations of which align with the evacuation hoses on the flexible, elastic, resilient adaptor. Such a rimmed size & shape retainer with opening(s) may be very slightly smaller than the open second end of the panel precursor so that it may be inserted and removed easily. It need not fit tightly since its purpose may not be to form a seal, but only to prevent the material at the open second end of the panel precursor from collapsing while the vacuum may be applied. It may be made of wood, plastic, polymer, metal or other appropriate material(s). It may be removed after the evacuation and sealing process, and may be reusable by the manufacturing facility. Retaining the size and shape of the end of the panel precursor throughout the evacuation process allows an air-tight seal between the adaptor and panel precursor throughout the evacuation process.

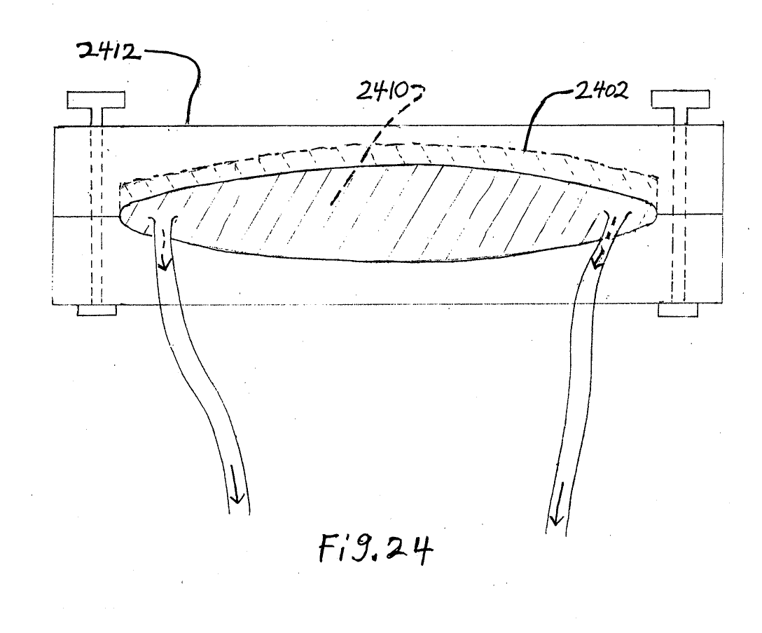

FIG. 24 is a perspective end-view of one alternative of an embodiment of the invention, showing details of manufacture.

Adaptor 2402 fits over the open second end of the non-rigid panel precursor, while rimmed size & shape retainer with opening(s) 2410 (not shown) fits therein. Exemplary clamp 2412 may be used to provide the sealing and securing in this embodiment.

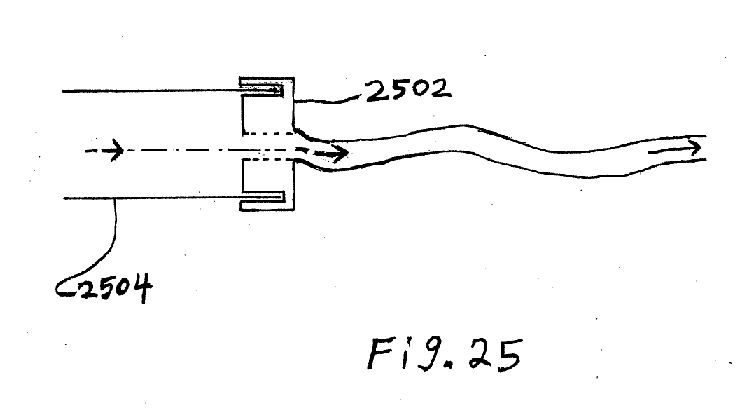

FIG. 25 is a cross-sectional side view of an alternative of an embodiment of the invention, showing details of manufacture in which the adaptor 2502 includes slotted size & shape retainer with opening(s) and hose(s) as a part of the unitary body of the adaptor. Slotted, flexible, elastic, size & shape retainer/adaptor with opening(s) and hose(s) 2502 fits inside of and over the perimeter of the open second end of the non-rigid panel precursor 2504 an appropriate distance, for example 1″. It comprises a slot wherein may be received the open second end of the panel precursor, and comprises a flange that fits around the outside of the panel precursor, an appropriate distance, for example 1″ and comprises opening(s) that may be a continuation of the evacuation hose(s). This slotted, flexible, elastic, size & shape retainer/adaptor with opening(s) and hose(s) may be made of one continuous seamless mold. If necessary, an elastic band or a clamp may be used to ensure an air-tight seal.

Use of an appropriate combination of a flexible, elastic, resilient adaptor, rimmed size & shape retainer with opening(s), slotted size & shape retainer/adaptor with opening(s) and hose(s), elastic bands, and/or clamps as herein exemplified may allow an air-tight seal throughout the evacuation process. However, ideally, an air-tight seal may be maintained throughout the evacuation process without the use of any elastic bands, clamps, or size and shape retainers if the adaptor is sufficiently flexible, elastic, and resilient, and can be tightly stretched over the end of the panel precursor. The vacuum action itself may draw the adaptor tightly to the panel precursor providing, or at least contributing to an air-tight seal throughout the evacuation process.

If a size and shape retainer is not used, the open second end of the panel precursor where the flexible, elastic adaptor may be attached may partially collapse. As long as an air-tight seal may be maintained throughout the evacuation process, such a partial collapse may be of no consequence in as much as the air flow may be maintained near the right and left convexly-curved side edges of the panel precursor, the side edges being resistant to collapse. Any partially collapsed material at the second end of the panel precursor may be severed and recycled after the conclusion of the evacuation and sealing process anyhow.

In regard to embodiments that may use an open second end of the panel precursor from which to evacuate the panel precursor, depending on the length of the area of excess material, it may be advantageous to use an alternatively designed rimmed size & shape retainer with opening(s) or an alternatively designed slotted size & shape retainer/adaptor with opening(s) and hose(s), either of which may extend lengthwise into the area of excess material 1716 an appropriate distance toward the end of the area of excess material where the second seal 1718 will be. Such a size and shape retainer may be generally wedge shaped lengthwise, the thicker end being at the open second end of the panel precursor and the thinner end terminating appropriately near the end of the area of excess material where the second seal 1718 will be. Thereby, the first and second walls within the area of excess material may be adequately supported and the material within the area of excess material may make a smooth transition in regard to its shape from the open second end 1710 to the second seal 1718 without buckling or tearing, etc. during evacuation and sealing. Thereby, an area of potential complete collapse exemplified in FIG. 17 and FIG. 18 may be eliminated. Any such size & shape retainer with openings may be reusable by the manufacturing facility.

Any appropriate combination of the number of vacuum pumps and number of hoses may be used, for example two hoses and two pumps, one bifurcated hose that has two openings on the adaptor but leads to one pump, etc. Evacuation by two pumps may increase the speed of the evacuation and/or increase the completeness of the vacuum for example, to the lowest reasonably-achievable internal pressure, giving the insulation panel the highest reasonably-achievable thermal R value.

In somewhat simplified general terms, many embodiments of the present invention may be rather concisely described and exemplified by the following five items and by observing FIGS. 14, 15a through k, 17, 18, 27, and 28 for example. As the evacuation process begins, the convexly-curved first and second walls of the panel precursor begin to contract inwardly. At the point in time at which the evacuation process may be complete, at least five exemplary events may occur nearly simultaneously. (1) The resulting very low internal pressure relatively precisely equals the pre-determined pressure desired by the manufacturer, for example the manufacturer's lowest reasonably-achievable pressure. (2) The previously cross-sectionally convexly-curved first and second walls have become generally rectilinear. (3) The outwardly-directed force of inertial tendency of the material of the newly-formed vacuum insulation panel to retain or return to the generally convex cross-sectional geometric shape of its non-rigid panel precursor, along with the outwardly-directed force of an optional adjustable pressure-exerting band if one is used, may be now be permanently in static and stable equilibrium with the inwardly-directed “force” of the permanently-retained internal vacuum and the inwardly-directed force of atmospheric pressure. (4) The cross-sectionally generally elliptical and convex panel precursor has been transformed into a predictably sized and shaped, generally planar, generally rectilinear, generally rectangular, hollow, thermal and sound building insulation panel having internal vacuum. (5) The end(s) may be sealed at the conclusion of the evacuation process while the vacuum pump(s) continues to run. Then the pump(s) may be turned off and excess panel precursor material severed and recycled. The insulation panel may then be encapsulated.

Evacuation transforms a non-rigid panel precursor having a generally elliptical cross-sectional shape, into a predictably sized and shaped, generally planar, generally rectilinear, generally rectangular, hollow, thermal and sound building insulation panel having internal vacuum. Stated differently, the shape of the panel precursor may be transformed into the shape of the insulation panel by a controlled partial implosion or controlled partial collapse. The concept of the inwardly-directed “force” of the vacuum being one of the forces that produces and permanently retains the final geometric size and shape of the device, and the concept of an optional adjustable pressure-exerting band exerting outwardly-directed pressure on the interior walls both during evacuation and permanently thereafter may be concepts of novelty of the present invention.

Regarding an embodiment of the invention, the final product which is the insulation panel, may be essentially identical whether the panel precursor is evacuated through open end(s) or through a punctured hole, etc.

The side edges of the panel precursor, being convexly-curved with a relatively small diameter, may be resistant to collapse. Therefore the side edges substantially retain their size and shape throughout the process of transformation from panel precursor to vacuum insulation panel.

Pertinent characteristics of the panel precursors should be suitable for use in producing insulation panels, and the characteristics should be consistent within a given stockpile of panel precursors. Respectively, the pre-determined very low pressure to which each may be evacuated should be relatively precise and consistent for each insulation panel produced from the given stockpile of panel precursors.

The lower the internal pressure of an insulation panel, the higher the thermal R value. Stated differently, the more complete the vacuum in the interior space of an insulation panel, the higher the thermal R value. Therefore a primary objective in manufacturing the insulation panels may be to evacuate the interior space to the lowest reasonably-achievable pressure. Therefore it may be advantageous for the manufacturer to firstly determine the measure of the lowest reasonably-achievable pressure, and then secondly make pre-production adjustments to the design of the panel precursor and/or optional adjustable pressure-exerting band accordingly. Stated differently and very simply, it may be advisable to adjust the panel precursor pre-production design to compatibility with the lowest reasonably-achievable pressure, rather than to adjust the pressure to compatibility with pre-production panel precursor design.

Precision and consistency regarding (A) the rate at which the evacuation takes place and (B) the internal pressure at the conclusion of the evacuation process function together with (1) precision and consistency in the characteristics of the panel precursors such as physical properties of the material such as softness, ductility, resilience, rigidity, and malleability etc., (2) size, (3) shape, (4) geometry, (5) material thickness, (6) force of optional adjustable pressure-exerting band if one is used, and (7) temperature at the time of evacuation, etc. to produce the desired sized and shaped vacuum insulation panel.

Stated differently and very simply: Manufacturer's lowest reasonably-achievable internal pressure=P, rigidity of material=Q, convexity of walls=R, thickness of material=S, and force of optional adjustable pressure-exerting band=T. If the material collapses too far, one or more of Q, R, S, or T may be increased. If the material does not collapse far enough, one or more of Q, R, S, or T may be decreased.

It may be advantageous to manufacture the present invention vacuum insulation panels at a factory located at an elevation of approximately the median elevation of the range of elevations within which the insulation panels will be installed.

It may be advantageous to warm or heat the panel precursor and its ambient air to an ideal temperature before evacuating the panel precursor.

The vacuum space between the interior surfaces of the first and second walls of the evacuated insulation panel may be engineered to be of any reasonable depth, but it may be likely that the depth of the vacuum space may be approximately, for example, 0.25″ to 1.0″, though the range may be lesser or greater.

The insulation panel itself may consist of nothing but sealed metal (or other suitable material), optionally with an adjustable pressure-exerting band (or optionally with a center support component). Its simplicity and stability may make it usable as a permanent component of buildings and other structures. Some embodiments may be produced by the following exemplary step-by-step process including the following concise, simplified list of items, for example:
produce seamless non-rigid panel precursor by extrusion or any other method;
cut to desired length plus, for example, 6″ to 2′ extra;
optionally install adjustable pressure-exerting band (or optionally install center support component);
seal first end of panel precursor;
optionally insert rimmed size & shape retainer with opening(s);
place flexible, elastic, resilient adaptor with hose(s) over open second end of panel precursor;
optionally, a slotted, flexible, elastic, size & shape retainer/adaptor with opening(s) and hose(s) may be used in place of the two previous steps;
optionally place elastic band into position around outside of adaptor and/or place clamp around outside of adaptor;
evacuate panel precursor;
seal panel precursor at second seal while vacuum pump(s) continue to run;
turn off vacuum pump(s) and remove clamp, elastic band, adaptor, size & shape retainer, etc.;
sever excess panel precursor material distally to the distal termination of the second seal and recycle the excess material;
encapsulate insulation panel in, for example, closed-cell polystyrene, polyisocyanurate, polyurethane, and/or other insulation material; and
ideally, the metal (or other material) of which the insulation panel may be made will reflect a satisfactory percentage of radiation, infrared radiation for example, but if not, at some point in the process, reflective materials and/or reflective coatings may be applied.

Of course, many options and alternatives are available. For example, as mentioned in regard to FIG. 15k, both ends may be used for evacuating a panel precursor and both ends may be sealed at the conclusion of the evacuation process, etc., etc. Also, if applicable, as discussed in reference to FIGS. 15g through 15k, a machine may exert downward pressure throughout a lengthwise portion of the panel precursor. If applicable, a machine may exert downward, or downward and upward pressure widthwise to loosely crimp the first and second walls together in order to restrain an optional pressure-exerting band in place, and/or to crimp the first and second walls together so they may be sealed, etc., etc. Loosely crimping walls together for restraining an optional pressure-exerting band in place might be unnecessary, but is mentioned as an option.

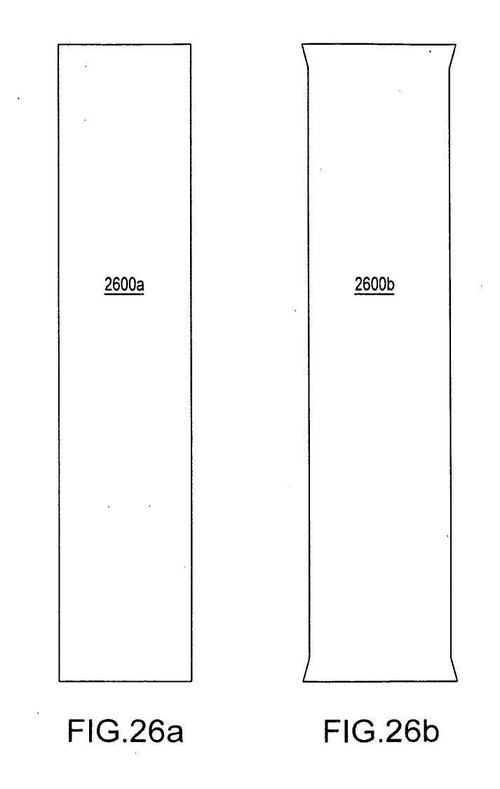

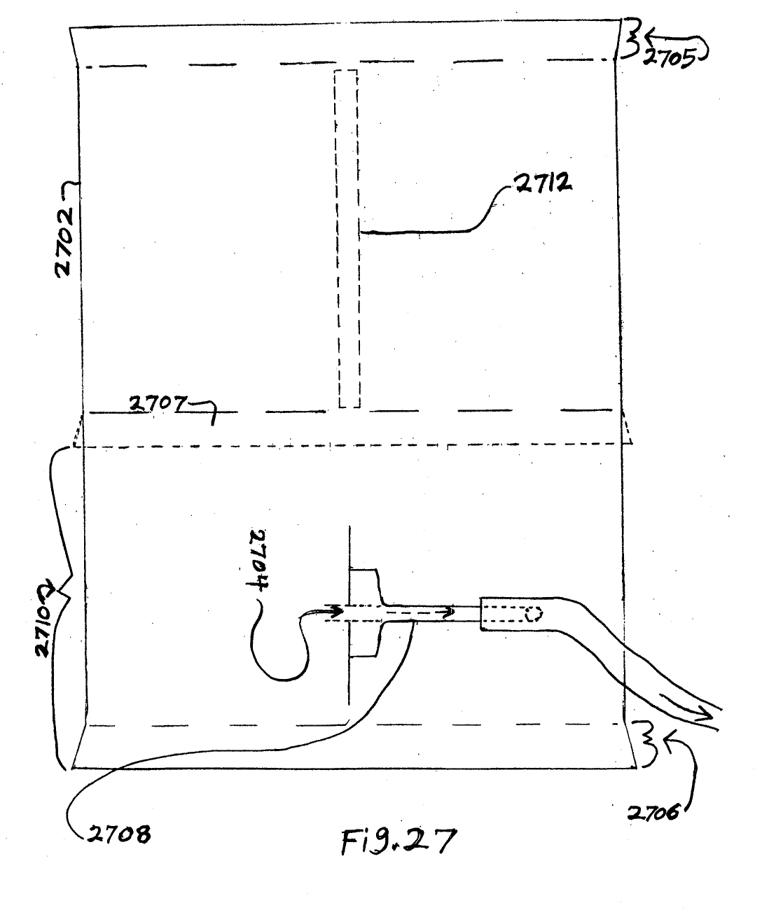

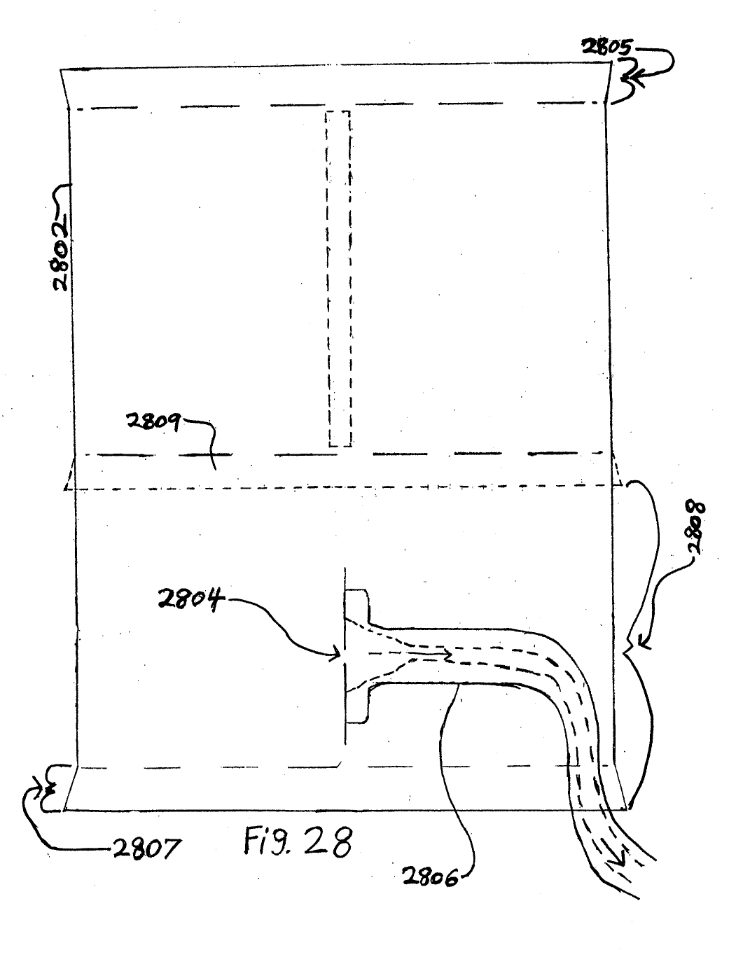

FIG. 26a and FIG. 26b show sealing of the invention during manufacture. Non-rigid panel precursor pre-seal 2600a and non-rigid panel precursor sealed 2600b may be seen. FIG. 26b exemplifies sealing of both ends prior to evacuation in embodiments wherein both ends may be sealed prior to evacuation such as the embodiments exemplified in FIG. 27 and FIG. 28, for example. FIG. 27 is a partially transparent perspective view showing details of alternatives of one embodiment of the invention and construction thereof. Non-rigid panel precursor 2702 has punctured hole 2704 which may be located within the area of excess material 2710 and will be removed when the area of excess material may be severed and recycled. Sealed first end 2705 and sealed second end 2706 may both be sealed prior to the evacuation. Third seal 2707 may be sealed at the conclusion of the evacuation process while the evacuation pump(s) continue(s) to run. Evacuation attachment 2708 is thus not an adaptor similar to those of the FIGS. 17 through 25, but rather a hose with an attachment/sealer extending therefrom. FIG. 28 is a partially transparent perspective view showing details of other alternatives of one embodiment of the invention and construction thereof. Non-rigid panel precursor 2802 has punctured hole 2804, and may be evacuated by an evacuation attachment 2806 of a different design than that of evacuation attachment 2708. Punctured hole 2804 may be located within the area of excess material 2808 and may be removed when the area of excess material may be severed and recycled. Sealed ends 2805 and 2807 may be sealed prior to evacuation and third seal 2809 may be sealed at the conclusion of the evacuation process while the evacuation pump(s) continue(s) to run.

Non-rigid panel precursor 2702, 2802 may be cut to the desired length plus approximately, for example, 6″ to 1′ extra length. An optional adjustable pressure-exerting band or an optional center support component optionally may be installed in the panel precursor. Then, both the first and second ends of the panel precursor may be sealed. Then a hole may be punctured in the non-rigid panel precursor by a pointed tool similar to an awl, or by a component of the evacuation attachment/sealer exemplified in FIGS. 27 and 28. Puncturing may be preferred over drilling because puncturing does not produce metal filings. The punctured hole 2704, 2804 may be located relatively near the sealed second end and may be at the side-by-side center point of the panel precursor, within the portion of the excess length of panel precursor material 2710, 2808 that will later be severed and recycled. An evacuation hose with, for example, a rigid cylindrical attachment/sealer 2708 on its end may be used in evacuating the panel precursor. The rigid attachment/sealer may encompass a relatively large, very pliable and supple sealer with an opening which may be placed over the punctured hole. The bottom of the pliable sealer contacts the exterior surface of the panel precursor and forms an air-tight seal. Many different designs of the evacuation hose, attachment, and sealer are contemplated—two are exemplified in FIGS. 27 and 28, but in any case an air tight seal may be formed around the punctured hole. The sealer may, for example, be made of a silicone or latex substance, or similar substance. The top surface of the housing which encompasses the pliable sealer and a section of the rigid attachment, etc. may have weights attached which gravitationally hold the sealer in tight contact with the exterior surface of the panel precursor. Also, for example, a machine or an employee may apply pressure on the sealer to form an air-tight seal around the punctured hole.

An exemplary alternatively-designed evacuation hose/attachment/sealer 2806 may comprise a pliable and supple substance. It may comprise a hose with an inside diameter greater than the diameter of the punctured hole, or else an enlargement of the end of the evacuation hose. The opening at the end of the hose or bottom of the sealer extends over the entire punctured hole and extends an appropriate distance beyond the perimeter of the punctured hole for 360 degrees around the punctured hole. Thereby an appropriate number of square centimeters of the exterior surface of the panel precursor surrounding the punctured hole may be subjected to the same vacuum action as that which evacuates the interior space of the panel precursor. The vacuum action acting upon this surface area draws the pliable hose end or sealer and the exterior surface of the panel precursor together to assist in forming an air-tight seal throughout the evacuation process. Also, weights, a machine, or an employee may apply additional pressure as needed to form an air-tight seal.

At the conclusion of the evacuation process, while the pump(s) continue(s) to run, the panel precursor may be sealed distally to the end of an optional adjustable pressure-exerting band or an optional center support component at third seal 2707, 2809. The pump(s) may then be turned off, and the hose, attachment/sealer, etc., may be removed. The excess length of the panel precursor may be severed distally to the distal termination of this third seal 2707, 2809. The excess material may be recycled.

In regard to embodiments that may use a punctured hole from which to evacuate the non-rigid panel precursor, a spacer (not shown in FIG. 27 or FIG. 28) may be temporarily inserted inside of the panel precursor within the area of excess material at and/or near the location of the punctured hole. It may be inserted before or after the hole is punctured. The spacer may comprise passages for air flow. It may be made of a rigid material such as metal, or a semi-rigid material such as rubber, etc., for example. The spacer may be relatively small, being shaped, for example like a spool, and having a diameter, for example, approximately equal to that of the attachment/sealer 2708, 2806 and may function to provide support for the wall of the panel precursor while the attachment/sealer is being pressed against the wall during evacuation. Alternatively, a coil spring or other form of spring may perform this function. The spacer may comprise passages for air flow, may be generally as “deep” as the inside of the panel precursor, and generally wedge-shaped lengthwise, the thicker end being at or near the location of the punctured hole and the thinner end terminating within the area of excess material appropriately near the end of the area of excess material where the third seal 2707, 2809 will be. Alternatively, it may be advantageous, determined for example by the location of the punctured hole in the lengthwise dimension of the area of excess material, for the spacer to be tapered in both lengthwise directions from a thicker center area near the punctured hole, becoming thinner toward both ends of the area of excess material. Thereby, the wall of the panel precursor may be supported while the attachment/sealer is pressed against it and both walls within the area of excess material may be adequately supported during evacuation and sealing. Thereby, the panel precursor material within the area of excess material may make a smooth transition in regard to its shape without buckling or tearing etc. during evacuation and sealing. Such a spacer may be of rigidity, size, and shape, etc., so as to function with the particular cross sectional size and shape of the non-rigid panel precursor that is being used, such as the cross-sectional sizes and shapes exemplified in FIG. 15a, FIG. 15c, FIGS. 15e,15g, and FIG. 15i, for example. The spacer may be removed after the area of excess material is severed and may be reused by the manufacturing facility.

Regarding the immediately-above-described exemplary method of producing an insulation panel of an embodiment of the invention, for example:
produce seamless non-rigid panel precursor by extrusion or any other method;
cut to desired length plus approximately, for example, 6″ to 2′ extra;
optionally install adjustable pressure-exerting band (or optionally install center support component);
optionally, insert temporary spacer;
seal both the first end and the second end of the panel precursor;
puncture hole in panel precursor;
place evacuation hose/attachment/sealer centered over the punctured hole;
evacuate panel precursor;
seal panel precursor at third seal while vacuum pump(s) continue(s) to run;
turn off vacuum pump(s) and remove hose/attachment/sealer;
sever excess panel precursor material distally to the distal termination of the third seal and recycle the excess material;
encapsulate insulation panel in, for example, closed-cell polystyrene, polyisocyanurate, polyurethane, and/or other insulation material; and
ideally, the metal (or other material) of which the insulation panel is made will reflect a satisfactory percentage of infrared radiation, but if not, at some point in the process, depending on the method used, reflective materials and/or coatings may be applied.

Of course, many options and alternatives are available. For example, if applicable, as discussed in reference to FIGS. 15g through 15k, a machine may exert downward pressure throughout a lengthwise portion of the panel precursor. If applicable, a machine may exert downward, or downward and upward pressure widthwise to loosely crimp the first and second walls together in order to restrain an optional pressure-exerting band in place, and/or to crimp the first and second walls together so they may be sealed, etc., etc. Loosely crimping walls together for restraining an optional pressure-exerting band in place might be unnecessary, but is mentioned as an option.

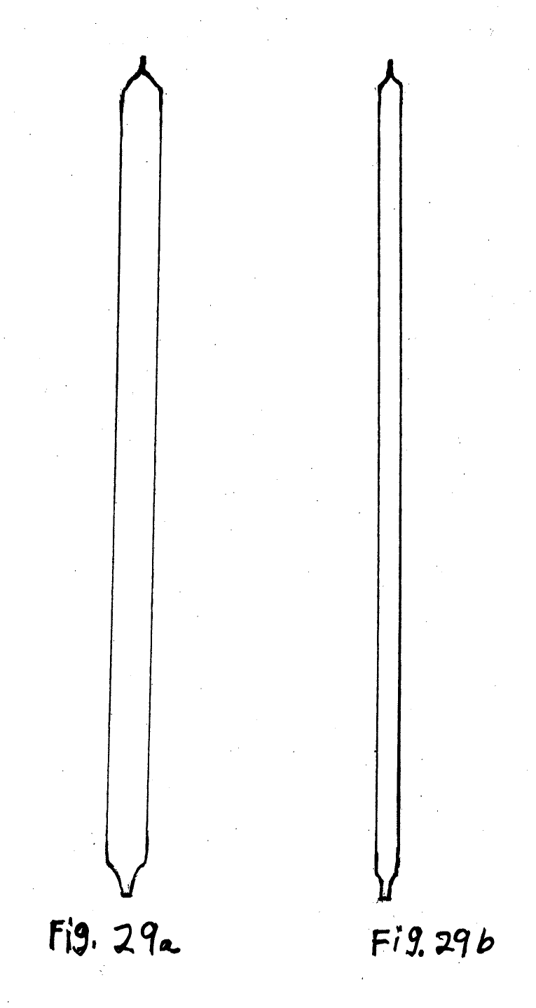

FIG. 29a and FIG. 29b are a pair of side views of the non-rigid panel precursor pre-evacuation and the insulation panel post evacuation of another embodiment of the invention. It may be seen that the material at the first sealed end may be comprised only of panel precursor material and may be relatively thin. The material at the second sealed end may be comprised of material of the panel precursor and also material of a permanently-installed slotted barrier/flange (evacuation port(s) not shown), and may be relatively thick.

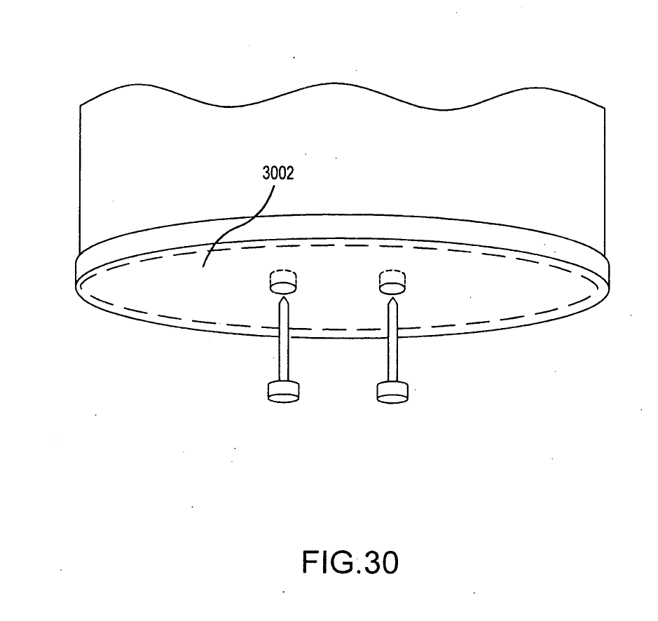

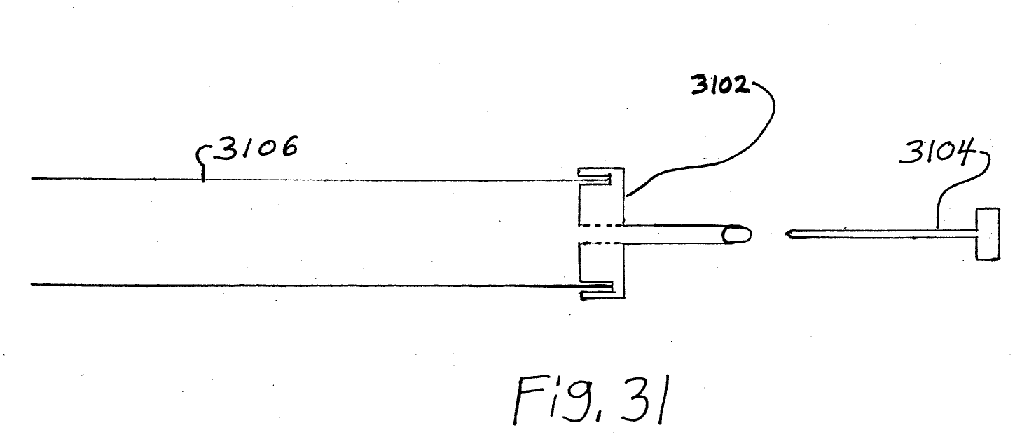

FIG. 30 is an end view of another embodiment of the invention and FIG. 31 is a cross-sectional side view of it, showing details of manufacture. Permanently-installed slotted barrier/flange/evacuation port 3002 and 3102 may be seen to be used with opening retainer 3104, which may be a solid rod temporarily inserted into and through permanently-installed slotted barrier/flange/evacuation port 3002, 3102 before sealing, and removed after sealing.

In this embodiment of the invention, an optional adjustable pressure-exerting band (or an optional center support component) may be installed inside of the non-rigid panel precursor 3106, then the first end of the panel precursor may be sealed. Then, a seamlessly molded, permanently-installed slotted barrier/flange/evacuation port may be placed permanently over the second end of the panel precursor. The permanently-installed slotted barrier/flange/evacuation port may be a single, continuously-molded, seamless component. The barrier may be the same size and shape as the cross-sectional inside dimensions of the panel precursor and extends an appropriate distance into the panel precursor, for example, a distance of 0.25″. In order to assist in acquiring a permanent air-tight seal, the permanently-installed slotted barrier/flange comprises a slot wherein fits the second end of the panel precursor, and a flange which fits over the exterior of the circumference of the second end of the panel precursor. The evacuation port(s) extend(s) perpendicularly to the widthwise dimension of the slotted barrier and panel precursor. The permanently-installed slotted barrier/flange may be sized and shaped to fit tightly over the second end of the panel precursor, and held in place by friction. The evacuation port could be cylindrically round but it may be advantageous to be cylindrically elliptical, the ellipse being oriented parallel to the widthwise dimension of the slotted barrier and the panel precursor. A hard, smooth, cylindrically-round opening retainer made of a smooth material, harder than the material of the panel precursor and the permanently-installed slotted barrier/flange/evacuation port may be temporarily inserted into the evacuation port and through the opening in the slotted barrier during which time the second end of the panel precursor and the permanently-installed slotted barrier/flange are sealed. Thereby, after sealing, which in this case may include crimping for example, the evacuation port has become a seamlessly-incorporated component of the panel precursor. The evacuation port(s) may be located to the right and/or left of the widthwise center of the panel precursor so the temporarily-inserted opening retainer does not have any contact with an optional adjustable pressure-exerting band (or an optional center support component) which may be located at the widthwise center point. After the sealing process, which in this case may include crimping for example, the hard, smooth cylindrically-round opening retainer(s) may be easily removed from the elliptically-shaped evacuation port(s) and the elliptically-shaped opening through the slotted barrier, by rotating and pulling. At this point of the process, the evacuation port(s) and panel precursor may be ready for the evacuation process. After evacuation, while the vacuum pump(s) is/are still running, the evacuation port(s) is/are sealed. It may be advantageous to seal the evacuation port(s) close to the insulation panel so that after severing the excess length of the evacuation port(s), the remnant of the evacuation port(s) is/are relatively short and comprise minimal mass.

After removal of the opening retainer(s), the opening(s) into the panel precursor may be relatively small. It may therefore be advisable to use two evacuation ports, one to the right and one to the left of the center of the panel precursor. The connection to the two evacuation ports may be from an evacuation pump with a bifurcated hose. Alternatively, the connection to the two evacuation ports may be a single connection to two evacuation pumps. Evacuation by two evacuation pumps may increase the speed of the evacuation and more importantly, increase the completeness of the vacuum, for example, to the lowest reasonably-achievable internal pressure, and the highest reasonably-achievable thermal R value of the insulation panel.

If sealing the second end of the panel precursor to the slotted barrier/flange causes excess material to protrude laterally, some of it may be trimmed off. The seamless permanently-installed slotted barrier/flange/evacuation port may advantageously be of the same material as that of the panel precursor, but may be of a different material.

An advantageous feature of some embodiments may be that an evacuation port seamlessly molded as a part of the permanently-installed slotted barrier/flange and made of relatively thick material strong enough to perform its function, is incorporated into the panel precursor which may be made of relatively thin metal, (or other suitable material)0.001″ to 0.005″ thick for example. Some embodiments may be produced by the following exemplary step-by-step process including the following concise, simplified, list of items, for example:
produce seamless non-rigid panel precursor by extrusion or any other method;
cut to desired length;
optionally install adjustable pressure-exerting band (or optionally install center support component);
seal first end of panel precursor;
permanently install slotted barrier/flange/evacuation port(s) over second end of panel precursor;
insert temporary cylindrically-round opening retainer(s) through cylindrically-elliptical laterally-oriented evacuation port(s) and through opening(s) in the slotted barrier;
seal second end of panel precursor and permanently-installed slotted barrier/flange;
rotate and remove temporary cylindrically-round opening retainer(s);
attach evacuation hose(s) to evacuation port(s);
evacuate panel precursor;
seal evacuation port(s) close to insulation panel, between insulation panel and end of evacuation hose(s) while vacuum pump(s) continue(s) to run;
turn off vacuum pump(s) and remove evacuation hose(s);
sever excess length of evacuation port(s);
encapsulate insulation panel in, for example, closed-cell polystyrene, polyisocyanurate, polyurethane, and/or other insulation material; and
ideally, the metal or other material of which the insulation panel is made will reflect a satisfactory percentage of infrared radiation, but if not, at some point in the process, reflective coatings and/or reflective materials may be applied.

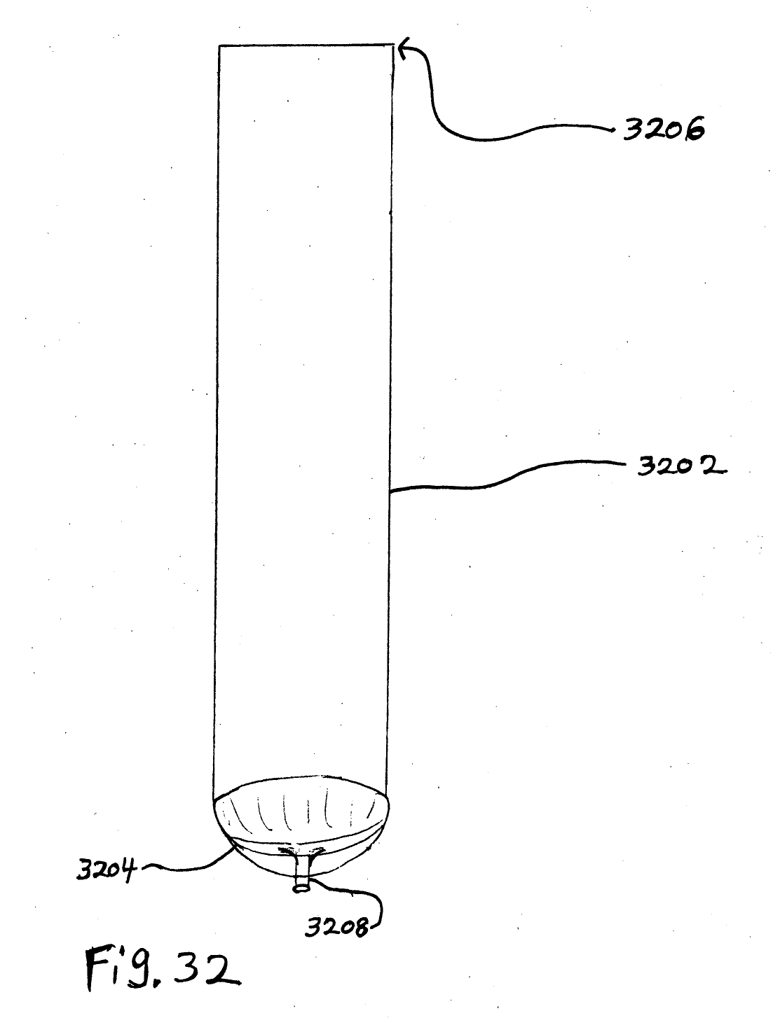

FIG. 32 is a side view of another embodiment of the invention. Non-rigid panel precursor 3202 has a convex end 3204 and a first sealable end 3206. Evacuation port 3208 located on convex end 3204 may be used to evacuate the panel precursor.

In this embodiment, a non-rigid panel precursor 3202 may be molded in a vertically-oriented mold for example, with a sealable first end 3206 and a convexly-curved seal/cap at the second end. The second end may comprise an evacuation port. The material at the center of this convexly-curved seal/cap, which may include an evacuation port or a suitable location wherein an evacuation port may be installed, may be thicker than the material of the rest of the panel precursor, the thicker material being advantageous for strength and support for the evacuation port, and/or its installation and sealing. The additional thickness thereof may protrude away distally from the convexly-curved seal/cap so as not to interfere with the precision of the thickness of the material medially therefrom which must contract inwardly a small distance during evacuation. The convexly-curved seal/cap may be relatively tall in proportion to its depth. Its base has the same cross-sectional shape as that of the panel precursor while its apex may be substantially the same shape as the cross-sectional shape of the insulation panel that may be the result of evacuating the panel precursor. Thereby, its material may collapse or implode the desired distance at the point where its base connects to the walls of the panel precursor while its material at its apex substantially retains its shape during and after the evacuation process.

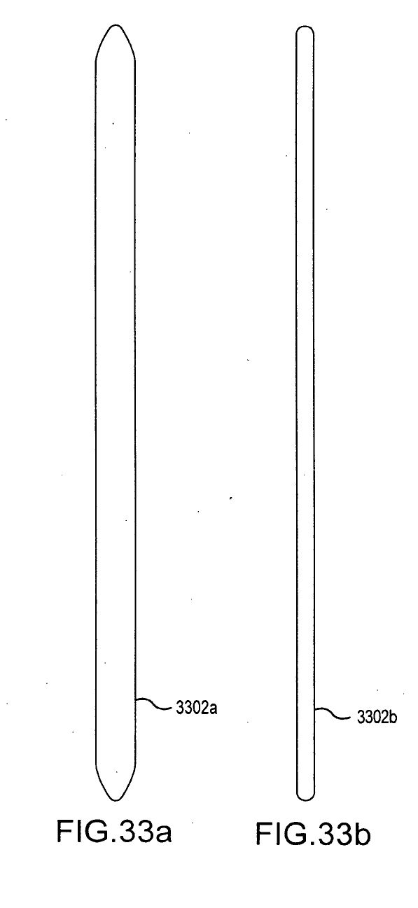

FIG. 33a and FIG. 33b are a pair of side views of a variation of another embodiment of the invention depicting a convexly curved seal/cap at both ends, pre-evacuation and post-evacuation. Panel precursor pre-evacuation 3302a and evacuated insulation panel 3302b show the thickness change which occurs as a result of evacuation.

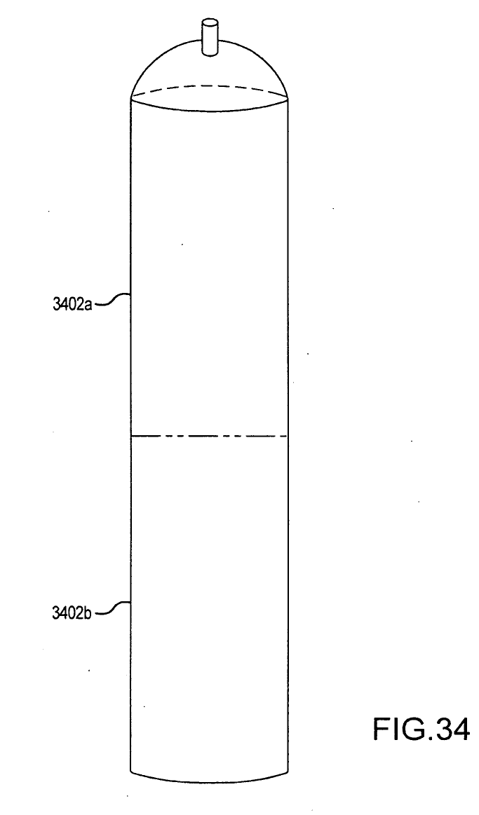

FIG. 34 is a perspective side view of an alternative of another embodiment of the invention. In this case first section 3402a and second section 3402b of a non-rigid panel precursor may be sealed together around the perimeter. In this embodiment the non-rigid first and second sections are sealed to each other around the perimeter, but the first and second walls thereof are not brought together and sealed together at this perimeter area. Then the panel precursor may be evacuated via evacuation port, punctured hole etc., for example.

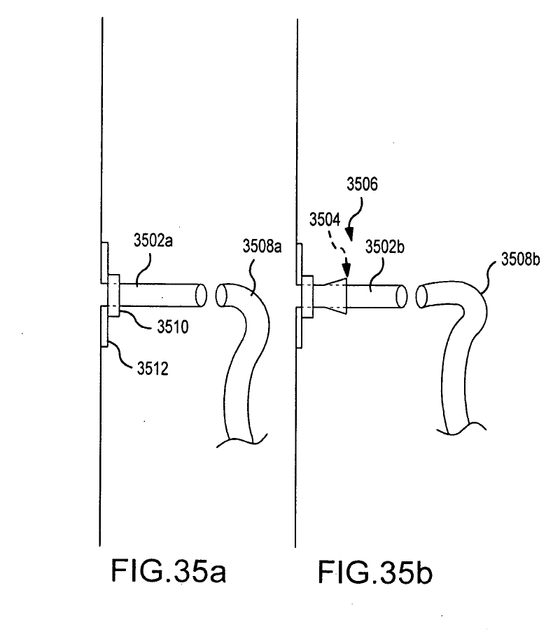

FIG. 35a and FIG. 35b are cross-sectional side views of an alternative exemplary embodiment of the invention. Evacuation port 3502a, 3502b is shown at earlier and later stages of production. Severing location 3504 marks the spot distal to the seal at which the port may be severed after evacuation and sealing. Evacuation hose 3508a, 3508b may attach directly to the port. Optional collar 3510 and optional plate 3512 may be used to strengthen the area around an evacuation port in any embodiment.

The non-rigid panel precursor comprises an evacuation port. The port may, for example, be molded or otherwise formed as a part of the panel precursor at the time it is manufactured, or, for example, after manufacturing, a hole may be punctured and used as an evacuation port or used wherein to install an evacuation port. An evacuation port may be located on a wall of the panel precursor, or located on a convexly-curved seal/cap, or on a side edge of the panel precursor. The evacuation port may be made of the same or of a different metal than the panel precursor. The evacuation port may be made of thicker material than that of the panel precursor. A reinforcing plate, circular for example, may be attached to the panel precursor where the evacuation port is to be installed. A further supportive collar or the like may encompass or otherwise support and/or seal the evacuation port. After evacuation, the evacuation port may be sealed by crimping for example, or by other method. Then the evacuation pump(s) may be turned off and the hose disconnected.

Alternatively, a separately-manufactured convexly-curved seal/cap may be sealed on to an end of the panel precursor.

Some embodiments of the invention may be produced by the following exemplary step-by-step process including the following concise, simplified list of items, for example:
produce seamless non-rigid panel precursor including a convexly-curved seal/cap on the bottom, the convexly-curved seal/cap including an evacuation port or a suitable location wherein an evacuation port may be installed;
optionally install adjustable pressure exerting band (or optionally install center support component);
seal first end of panel precursor;
attach evacuation hose to evacuation port;
evacuate panel precursor;
seal evacuation port close to insulation panel, while vacuum pump continues to run;
turn off vacuum pump and remove evacuation hose;
sever excess length of evacuation port;
encapsulate insulation panel in, for example, closed-cell polystyrene, polyisocyanurate, polyurethane, and/or other insulation materials; and
ideally, the metal or other material of which the insulation panel is made will reflect a satisfactory percentage of infrared radiation, but if not, at some point in the process, reflective coatings and/or reflective materials may be applied.

It is likely that the relatively thin present invention insulation panels will, at the time they are manufactured at a factory, be completely encapsulated in a protective, rigid, or semi-rigid, conventional insulation material such as, for example, closed-cell polystyrene, polyisocyanurate, or polyurethane or other materials or combinations thereof. This will provide:
direct contact of the panel only with the encapsulating insulation material and/or an air space inside of the encapsulation insulation material;
safety;
ease of handling and shipping;
physical support for the insulation panel so it does not bend or buckle, for example;
protection for the insulation panels, protection from moisture for example;
ease of installation, for example a labor-efficient “friction fit” within architectural cavities or framing components;
additional sound transmission reduction and additional sound absorption;
additional thermal R value;
function as a vapor barrier, and
potential reflective material on one or both walls of the encapsulating insulation material for reflecting heat in the form of radiation, infrared radiation for example.

It may be advantageous for encapsulating insulation material, closed-cell polystyrene for example, to have the form of a “pouch” or “sock” with a “lid” at one end. The insulation panel may be inserted through the open end of the “pouch” or “sock.” The goal being to have the smallest reasonable linear length of adjoining seam length between the encapsulating body and its lid. The lid may be “T-shaped” and thereby designed to fit frictionally tightly and to prevent entrance of water vapor, thereby minimizing permeation of water vapor into the device, and enhancing the vapor barrier capability of the encapsulating material.

The sides and/or top and bottom of the encapsulating insulation material may comprise, for example, rounded or beveled edges in order to facilitate easy friction-fit installation with minimal force, pressure, or stress applied during installation.

Encapsulating insulation material such as closed-cell polystyrene or polyurethane foam for example may, among its functions, protect the insulation panels from exposure to moisture. The insulation panels may be impenetrable to water and water vapor. Also, the encapsulating insulation material, closed-cell polystyrene for example, may be impenetrable to water and water vapor. Therefore present invention encapsulated insulation panels may function as a vapor barrier and may not be subject to a reduction in its thermal R value on humid days, in humid climates, or if accidentally or otherwise exposed to moisture as are many conventional insulation products such as fiberglass or mineral wool, etc.

Present invention insulation panels may be relatively thin, which may be normally desirable in construction, but could, in variations, be quite thick as allowed by the type of construction of the overall building or structure. The panels may be encapsulated in a rigid, or semi-rigid conventional insulation material, and typically (but not absolutely necessarily) installed toward the back, or exterior of walls, behind, or exterior to, plumbing, wires, electrical outlet boxes, and electrical switch boxes, etc. The insulation panels may be installed either prior to, or after installation of plumbing and electrical components for example. Depending on circumstances, some insulation panels may be installed prior to installation of plumbing and electrical components and heat ducts, etc., and some may be installed after. If installed after installation of plumbing and electrical components for example, in some architectural cavities, for example, two nominally 4 foot long encapsulated panels may be easier to install than a single nominally 8 foot long encapsulated panel. If an encapsulated panel does not friction-fit or gravitationally fit in a given cavity, support members sometimes called “L-Rods” may be used to hold it in place. Installing encapsulated present invention insulation panels toward the outer, or exterior of the depth of, a typical 2×6, 2×8, or 2×10 framed exterior wall, immediately interior to the exterior siding material for example, will leave substantial space in front of, or interior to the panels for other optional conventional materials and plumbing and electrical components, etc. A 2×4 wall and/or typically-sized furring strips will leave less space. It may be advantageous to install present invention insulation panels after installation of exterior siding materials and prior to installation of such things as plumbing and electrical components and heat ducts, etc. Complementary conventional insulation and other materials may be easily cut with a utility knife to custom fit around obstacles and easily cut to fit into irregularly-shaped and irregularly-sized architectural cavities. The wall depth space in front of, or interior to, the present invention insulation panels will also provide space for drilling holes and installing fasteners such as toggle bolts or anchors for installing such things as cabinets, shelves, mirrors, or paintings etc., on the finished interior wall, without contacting or damaging the present invention insulation panels. Of course present invention insulation panels do not affect direct access from the exterior or interior of the wall to the exterior or interior surfaces of wall studs whereon may be fastened such things as exterior siding, interior finished wall material, and such things as cabinets, shelves, paintings, etc.

In a typical attic installation, many options exist. Depending on circumstances, for example, encapsulated present invention insulation panels may be installed above, or superior to previously installed conventional insulation, or may be installed for example below other concurrently installed conventional materials or attic flooring, etc. A relatively high percentage of the square footage of a typical attic floor may be fitted or retrofitted with encapsulated present invention insulation panels since there may be relatively few obstacles on the attic floor. Also, the panels may be laid on top of attic framing parallel to or perpendicularly to the framing with very few obstacles. The attic floors of existing houses and/or other buildings or structures may be easily retrofitted with current invention insulation panels. Retrofitting on already-existing attic floors of houses and/or other buildings may constitute a substantial amount of usage of encapsulated present invention insulation panels.

It is possible that present invention insulation panels may be manufactured in a reasonable variety of lengths and widths in order that they may fit into as high of a percentage of architectural cavities in a building, or other structure, as possible. Where they will not fit, conventional insulation may be used.

Regarding walls: standard-sized metal-framed architectural cavities may be typically approximately one inch wider, and approximately two inches taller, than standard-sized wood-framed architectural cavities. This may be because wood framing material is typically rectangularly-shaped. Conversely, metal framing material may be typically [-shaped, or concavely-shaped. Metal vertical studs and top and bottom rails or channels may be typically [-shaped, or concavely-shaped in various sizes and dimensions. Also, standard metal studs may be typically of different lengths than standard wood studs. For economy, if desired, present invention insulation panels may be manufactured in the same standard sizes for use in wood-framed cavities, and also for use in the slightly larger-sized metal-framed cavities. However, the encapsulating insulation material which encapsulates an insulation panel may be manufactured in different sizes, first, with outside dimensions for fitting wood-framed cavities, and secondly, with outside dimensions for fitting slightly larger-sized metal-framed cavities.

The following describes sizes of two exemplary panels according to the invention:

Exemplary sizes for installation in wood framing, 16″ on center, in a nominal 8′ tall wall:

| | |
|---|---|
| Cavity Width = | 14.5″ |
| Panel Width = | 13.25″ |
| Encapsulating insulation on each side = | 0.5″ |
| Total Width = | 14.25″ |
| Cavity Length = | 92.625″ |
| Panel Length = | 90.75″ |
| Encapsulating insulation top & bottom = | 0.75″ |
| Total Length = | 92.25″ |

Exemplary sizes for installation in metal framing, 16″ on center, in a nominal 8′ tall wall:

| | |
|---|---|
| Cavity Width = | 15.5″ |
| Panel Width = | 13.25″ |
| Encapsulating insulation on each side = | 1.0″ |
| Total Width = | 15.25″ |
| Cavity Length = | 95.5″ |
| Panel Length = | 90.75″ |
| Encapsulating insulation top & bottom = | 1.75″ |
| Total Length = | 94.25″ |

Per table two and three above, for example, for economy, the insulation panels may, if desired, be manufactured the same size, only the size of the encapsulating insulation material changes. Many variations may be possible regarding the physical dimensions of the present invention insulation panels and encapsulating insulation material.

In general, regarding a typical exterior wall, in a typical climate, in winter, heat may be transferred from the heated air inside of the building to the air outside of the building. In summer, heat may be similarly transferred from the air outside of the building to the air-conditioned air inside of the building. In variations, if the encapsulated vacuum insulation panels are manufactured with only one reflective surface, they may be installed with the reflective surface facing the interior of the building to prioritize keeping heat inside the building in a cold climate for example, or facing the exterior of the building to prioritize keeping heat outside the building in a hot climate for example. Ideally, the metal of which a present invention panel may be made will reflect a satisfactory percentage of radiation from both its first wall and its second wall. Alternatively, the vacuum insulation panels and/or the encapsulating insulation material may comprise separate reflective material on one or more than one surface, or no reflective surfaces at all.

The amount of heat conducted or convected through the vacuum space of a present invention vacuum panel may be negligible. Reflective surfaces may minimize the amount transferred through the vacuum space by radiation.

The non-insulating metal, (or glass, or other material), of which a present invention insulation panel may be constructed, may be in direct contact only with the conventional insulation material in which it may be encapsulated and/or an air space inside of the encapsulating material. Whereas some heat may be conducted from a first wall to a second wall of a vacuum insulation panel by being conducted around the sides, top and bottom, the heat conduction thereof may be minimal if the non-rigid panel precursor and the insulation panel are made of relatively thin material such as an aluminum alloy, approximately 0.001″ to 0.005″ thick for example, thereby comprising a minimal quantity of total mass. The thickness of the material may be lesser or greater than the exemplary range of 0.001″ to 0.005″, but in any case may be relatively thin and comprise a minimal quantity of total mass. Also, the fact that the panel itself may be in direct contact only with its encapsulating insulation material and/or an air space inside of the encapsulating material may significantly reduce the amount of heat transferred by conduction around the sides and top and bottom, from a first wall to a second wall of a present invention encapsulated insulation panel.

In order to achieve an even higher thermal R value in an exterior wall, it may be advantageous to use the present invention insulation panels in conjunction with exterior wall construction wherein the wall actually consists of two juxtapositioned walls such as two “2×4” walls instead of one “2×8” wall for example. In this case the studs in the two walls are arrayed staggered from each other. For example, one wall may have studs located at 16″, 32″, and 48″, etc., and the juxtapositioned wall may have studs located at 8″, 24″, 40″, etc., both being standard 16″ on-center spacing, but staggered relative to each other. Furthermore, there may be an insulating spacer or an air space between the top and bottom plates of the two walls. Thereby, there is no direct path of heat conduction all the way through the wall via the framing of the wall. In this case, the present invention insulation panels may be, but are not necessarily installed between the studs of the wall that is the outer or exterior wall.

In a similar type of exterior wall construction the top and bottom plates may be for example “2×6”, “2×8”, or “2×10” framing material but the staggered studs may be of a size smaller than the top and bottom plates. In this case, the staggered studs being of a width or depth less than that of the whole wall do not provide a direct path of heat conduction all the way through the wall via the framing of the wall. In this case, it is one wall, not two juxtapositioned walls, and again for example, the insulation panels may be, but are not necessarily installed between the staggered studs that are located along the exterior of the wall.

In general, moisture and humidity reduce the thermal R value of most conventional insulation materials, fiberglass and mineral wool for example. This thermal R value reduction may occur temporarily during times of wet, humid weather during which the moisture content within the insulation material may be relatively high. This may be because water as a liquid or as a gas efficiently transfers heat by convection. Furthermore, the thermal R value reduction may be permanent if moisture compacts or compresses the insulation material. Depending on the climate and on the type(s) of conventional insulation material(s) and vapor barriers used, etc., a wide variety of conditions and circumstances may exist. Conversely, present invention insulation panels, if made of metal, an alloy of aluminum for example, (or glass, or other material), regardless of the type of insulation material that may encapsulate the panel, may be impenetrable to moisture, the panel itself functioning as a vapor barrier. Also, encapsulating insulation material such as closed-cell polystyrene for example may also be impenetrable to moisture and function as a vapor barrier in the wall, ceiling, attic, etc. In general, the panels and/or the encapsulating insulation material may therefore impede the permeation or diffusion of moisture in walls, ceilings, attics, etc. Encapsulated insulation panels therefore are not subject to thermal R value reductions on humid days or in humid climates. Encapsulated insulation panels prevent heat transfer by convection by moisture and water vapor. Encapsulating material impermeable to moisture may also protect the encapsulated panel.

Since the metal, an alloy of aluminum for example, (or glass, or other material) of which a present invention insulation panel is constructed may be impenetrable to liquids and gasses, water and water vapor for example, and since the encapsulating insulation material, closed-cell polystyrene or polyurethane for example, may also be impermeable to liquids and gasses such as water and water vapor, the encapsulated panels may reduce heat transfer by convection horizontally through a wall. However, most heat transfer by convection does not occur horizontally, but occurs in an upwardly direction as warm air rises and cooler air may be drawn in to replace it. Therefore, when installed in a floor, ceiling, attic, or roof, the impenetrable encapsulated present invention insulation panels may function to reduce vertical heat transfer by convection.

If present invention insulation panels are constructed of metal, an alloy of aluminum for example, depending on the type of metal used, the reflective surfaces of the metal may function to reflect a satisfactory percentage of heat in the form of radiation, infrared radiation for example. If the present invention insulation panels are constructed of a type of metal the surfaces of which do not reflect a satisfactory percentage of infrared radiation, (or is made of a type of glass or other material that does not satisfactorily reflect infrared radiation), a reflective coating, or a separate reflective material, aluminum foil for example, may be applied to the front and/or back surface(s) of the present invention insulation panels. Alternatively, reflective material, aluminum foil for example, may be applied or attached to the encapsulating insulation material and may reflect radiation, infrared radiation for example, away from the front and/or back surface(s) of the material. The encapsulating insulation material, for example may comprise reflective material on interior surfaces, or on its exterior surfaces, or both. It is generally believed, but often not put into practice in reality, that a surface intended to reflect infrared radiation functions most efficiently if there is an air space in front of the surface. Also, a reflective surface may function efficiently if it is in direct contact with basically any conventional insulation material because any conventional insulation material such as that used to encapsulate the insulation panels contains air space to the extent that, like an air space, it allows the reflective surface to reflect infrared radiation efficiently. Therefore, if present invention insulation panels are constructed of a metal (or other material) that reflects a satisfactory percentage of infrared radiation, or if reflective surfaces or reflective materials are applied to the panel, the reflection may function efficiently because the panel may be in direct contact only with the conventional insulation material in which the panels may be encapsulated and/or an air space inside the encapsulating material. Alternatively, any optional complementary conventional materials that may be used in conjunction with the present invention insulation panels, may comprise one or more reflective surfaces, reflective coatings, and/or reflective materials. Alternatively, no reflective surfaces may be used at all.

The vacuum space may function to reduce sound transmission. The encapsulating insulation material may function to absorb sound, thereby effecting noise reduction.

Many variations may be possible in manufacturing an encapsulated present invention insulation panel which may provide very high thermal and sound R values. Various physical aspects of present invention insulation panels should be coordinated to exist and function compatibly with other physical aspects of present invention insulation panels. Economics, goals, prioritization, requirements, and desires, etc. should be considered. For example:
the thinner the panels are, the more space there will be available for other conventional materials, and plumbing and electrical components, etc., and the less it will cost to manufacture each panel;
the more complete the vacuum, the higher the thermal R value of the panel;
the more different sizes of panels that are manufactured, the higher of a percentage of a building may be fitted with present invention insulation panels.

Present invention insulation panels may be constructed of a type of metal, an alloy of aluminum for example, that reflects a satisfactory percentage of radiation, infrared radiation for example, (or may be made of a type of glass, or other suitable material, with reflective coatings on the surfaces), or a separate reflective material may be used, for example a type of aluminum foil. Present invention insulation panels may be typically encapsulated in conventional insulation material which itself provides a substantial sound and thermal R value, and which may comprise reflective materials, and, which may function as a vapor barrier. Therefore, if the vacuum is partially, or even completely lost in a reasonable percentage of present invention insulation panels in a given building or other structure, because of damage or manufacturing defect, for example, the present invention insulation panel would then spontaneously fill with air. The resulting air space, along with the insulation material that encapsulates the present invention insulation panel, and reflective surfaces etc., would continue, without the vacuum, to perform all of the functions as intended at the time of the installation, except with a lower sound and thermal R value. The sound and thermal R values may still be acceptable regarding the insulation in a given architectural cavity in which the vacuum was lost, and certainly acceptable in regard to the building or other structure as a whole.

It may be estimated that the thermal R value of a Dewar's vessel is approximately R 250. Whereas the thermal R value of an encapsulated present invention insulation panel may be less than R 250, encapsulated present invention insulation panels, when used appropriately, may provide noise reduction, and more importantly, thermal R values much higher than any prior art insulation system available at the time of this writing, and may be designed to be well-suited for “permanent” use in residential, commercial, and industrial buildings, and other structures.

An insulation panel may be made of material, an alloy of aluminum for example, approximately 0.001″ to 0.005″ thick, for example. The thickness of the material may be lesser or greater than this range but in any case is relatively thin and the insulation panel may comprise a minimal quantity of total mass. The thickness or depth of the panel may equal an exemplary and approximate total depth or thickness in the range of only 0.25″ to 1.0″ for example, though the thickness or depth may be lesser or greater than this range. Therefore, even when encapsulated in insulation material, the thickness or depth of the encapsulated insulation panel may be relatively thin. Therefore, as discussed elsewhere in this writing, after installation of the present invention encapsulated insulation panels toward the outer or exterior of a typical wall depth space, a substantial amount of space remains in a typical architectural cavity, a nominal “2×6” wall cavity for example, wherein to install electrical wires, electrical boxes, plumbing, optional conventional materials, etc., and to have space for drilling holes and installing fasteners such as anchors and toggle bolts for installing items such as cabinets or shelves, or for hanging paintings, etc. on the interior walls of a building. Of course, the exterior and interior surfaces of wall studs are not affected by present invention encapsulated insulation panels and are available for use in fastening exterior siding and interior finished wall material.

In variations, the encapsulating insulation material may tightly encapsulate the insulation panel of any of the embodiments, directly contacting generally the entire exterior surface of the insulation panel.

In variations, the encapsulating insulation material may be configured to loosely encapsulate the insulation panel thereby providing an air space between the exterior of the first and second walls of the insulation panel and the encapsulating insulation material. There may also be an air space between the ends and side edges of the panel and the encapsulating material. With this configuration, there may be only a small amount of direct contact. In order to provide an air space between the encapsulating insulation material and the insulation panel when the device is installed “lying down” horizontally, for example in an installation on the attic floor of a building, the encapsulating insulation material may comprise a rib or ridge or other protrusion on its interior surfaces which may directly contact the insulation panel and function to hold the insulation panel in the center of the air space. This configuration may minimize gravitationally-induced direct contact of the insulation panel with the encapsulating insulation material regardless of the orientation of the device after it is installed, the surface area of the rib, ridge, or protrusion being minimal.

In variations, depending on the type of metal used, the first and second walls of a panel precursor may themselves be magnetized throughout the entire length of the panel precursor. In variations, appropriate areas of the first and second walls may be magnetized, or the entire panel precursor may be magnetized. This may involve magnetizing generally the entire panel precursor throughout its entire length, or may involve magnetizing a relatively wide strip of both walls at the widthwise center of the panel precursor throughout the entire longitudinal length for example. This magnetization may cause the walls of the insulation panel made from the panel precursor to repel each other and assist in permanently maintaining a desired distance between the two walls of the insulation panel. Furthermore, the repulsion of magnetized first and second walls of an insulation panel may desirably allow for the production of insulation panels with a vacuum space “thinner” or of less depth, than may otherwise be reasonably achievable.

In variations, depending on the type of metal used, an alternative optional center support component consisting of a small magnet may be placed inside of the panel precursor at the side to side center and end to end center of the panel for example, providing some support but being very minimal in conducting heat through the relatively large vacuum area of the panel.

In variations, encapsulating insulation material may not be rigid or semi-rigid, but may be flexible such as un-faced, kraft-faced, or foil-faced fiberglass insulation, for example.

In variations, an optional adjustable pressure-exerting band (or an optional center support component) may be installed in a panel precursor. Both ends may be sealed. A hole may be punctured in the panel precursor wherein may be installed an evacuation port. The evacuation port may be installed by threaded device, pressing, welding, frictional device, brazing, or other method that will provide an air-tight seal. The panel precursor may be evacuated. At the conclusion of the evacuation process, while the pump continues to run, the evacuation port may be sealed, for example by crimping near the insulation panel between the insulation panel and the end of the evacuation hose. The pump may be turned off and the hose removed. The excess length of the evacuation port may be severed. Then, the insulation panel may be encapsulated in insulation material. In this variation, there may be no excess panel precursor material to sever.

In variations, an optional rod-shaped center support component may be produced separately and attached to a convexly-curved first seal/cap and may extend to a receptacle located on the second convexly-curved seal/cap. Also, a slotted barrier/flange/evacuation port could comprise a receptacle at its center point to receive one end of an optional rod-shaped center support component.

In variations, a panel precursor may be produced from sheet metal, by using a skelp and a mandrel for example. A seam may extend the entire length or width of the panel precursor. The seam may be located anywhere on the panel precursor, but it may be advantageous to locate the seam along a convexly-curved collapse-resistant side edge where the material moves very little during the evacuation process. The seam may be sealed, an optional adjustable pressure-exerting band (or an optional center support component) may be installed, then any of the methods of sealing and evacuating etc. discussed elsewhere in this writing may be used to transform the panel precursor into an insulation panel.

In variations, protective material, insulating or non-insulating, such as plywood for example, may be attached, for example, glued and/or strapped on to the front and/or back surfaces of the encapsulating insulation material, but in variations not on the ends, or sides.

In variations, in producing encapsulated insulation panels for use in relatively wide architectural spaces, for 24″ or 48″ on center framing for example, two or more insulation panels may be encapsulated side-by-side in one encapsulating system.

In variations, an evacuated building insulation panel may be contained in combination with building materials or components, structural or non-structural. For example, the insulation panels, encapsulated or not, may be contained in combination with wall materials or components comprising exterior siding materials and/or interior wall materials, or in combination with roofing materials or components, or in combination with flooring or ceiling materials or components. Such exemplary combinations may be pre-fabricated combination insulation/building materials or pre-fabricated combination insulation/structural building components.

Vacuum insulation panels, potentially encapsulated in, and/or protected by an appropriate material may be contained in combination with a very diverse range of building materials and/or components potentially including for example, concrete walls and suspended ceiling tiles.

In variations, the sealing of one or more ends of a panel precursor may be accomplished as a part of the process of producing the panel precursor, for example by molding or extrusion.

In variations, a cross sectional shape of an insulation panel as exemplified in FIGS. 15d, 15f, 15h, and 15j for example, along with the resilience of a panel precursor with a great measure of vertical convexivity such as exemplified in FIG. 15g and FIG. 15i, and the inertial tendency of the evacuated insulation panel to retain or return to the shape of a panel precursor with a great measure of vertical convexivity may provide enough strength and outwardly-directed pressure as to completely eliminate the need for any optional adjustable pressure-exerting band (or optional center support component) whatsoever.

In variations, for example, a non-rigid panel precursor may be produced by extrusion or by any other method. Panel precursor parts, ends, sides, and seams, etc., thereof may be sealed during the process of producing the panel precursor, or may be sealed before or at the conclusion of the evacuation process while the pump continues to run.

In variations, a vacuum insulation panel may comprise for example a material such as an alloy of aluminum known not to outgas, on the “inside” and may be laminated to another material, outgassing or not, on the “outside”.

In variations, depending on the type of metal used, a component such as an optional adjustable pressure-exerting band may be magnetized so that opposing portions of the component may repel each other across the vacuum space and thereby further assist in permanently keeping the two walls apart.

In variations, getters and/or desiccants may be used inside of a vacuum insulation panel.

In variations, if it makes manufacturing easier or is otherwise advantageous, for example, two 6.625″ wide insulation panels instead of one 13.25″ wide insulation panel may be manufactured and installed in a single encapsulating unit, or may be installed in two encapsulating units, for example.

In variations, if it makes manufacturing easier or is otherwise advantageous, for example, two nominally 4′ long panels instead of one nominally 8′ panel may be manufactured and installed in a single encapsulating unit, or may be installed in two encapsulating units, for example.

In variations, additional or various sizes and shapes of encapsulated insulation panels may be manufactured.

All information provided in this writing regarding any embodiment and/or any variation and/or any combination thereof may be considered to be potentially applicable to all embodiments and/or all variations and/or all combinations thereof.

The invention has now been described in detail for the purposes of clarity and understanding. However, it will be appreciated that certain changes and modifications may be practiced within the scope of the appended claims.

1. A system for insulating a structure, wherein the system comprises:
an insulation panel, wherein:
the insulation panel defines an internal volume;
the internal volume is at a lower pressure than an exterior of the insulation panel; and
the insulation panel is disposed within a portion of the structure.

2. The system for insulating a structure of claim 1, wherein the insulation panel comprises a substantially elliptical cross-sectional shape.

3. The system for insulating a structure of claim 1, wherein the insulation panel comprises a first cross-sectional shape, and wherein the first cross-sectional shape is different than a second cross-sectional shape of the insulation panel if the pressure of the internal volume is equalized with the exterior of the insulation panel.

4. The system for insulating a structure of claim 1, wherein the insulation panel comprises a continuous seamless material.

5. The system for insulating a structure of claim 1, wherein the insulation panel comprises an evacuation port.

6. The system for insulating a structure of claim 1, wherein the insulation panel comprises at least one selection from a group consisting of:
metal alloy;
steel;
galvanized steel;
stainless steel;
aluminum;
polymer;
ceramic; and
glass.

7. The system for insulating a structure of claim 1, wherein the insulation panel comprises a material having a substantially reflective surface on at least one surface.

8. The system for insulating a structure of claim 1, wherein the system further comprises a reflective material disposed on at least a portion of the insulation panel.

9. The system for insulating a structure of claim 1, wherein the system further comprises an insulation material disposed on the exterior of the insulation panel.

10. The system for insulating a structure of claim 9, wherein the insulation material comprises at least one selection from a group consisting of:
polystyrene;
polyisocyanurate; and
polyurethane.

11. The system for insulating a structure of claim 1, wherein the lower pressure is between about 3 kilopascals and about 100 kilopascals.

12. The system for insulating a structure of claim 1, wherein the lower pressure is between about 100 millipascals and about 3 kilopascals.

13. The system for insulating a structure of claim 1, wherein the lower pressure is between about 100 nanopascals and about 100 millipascals.

14. The system for insulating a structure of claim 1, wherein the insulation panel is configured to be disposed between a pair of wall studs in the structure.

15. The system for insulating a structure of claim 1, wherein the insulation panel comprises a cross-section having a greater moment of inertia in a first axis than in a second axis orthogonal to the first axis.

16. The system for insulating a structure of claim 1, wherein the system further comprises an adjustable pressure-exerting band disposed within the internal volume and configured to maintain a distance, internally, between two portions of the insulation panel.

17. A method for manufacturing an insulation panel, wherein the method comprises:
providing a panel precursor, wherein the panel precursor defines an internal volume;
reducing the pressure of the internal volume; and
sealing the internal volume from an exterior of the panel precursor to create the insulation panel.

18. The method for manufacturing an insulation panel of claim 17, wherein the method further comprises encapsulating the insulation panel in an insulation material.

19. The method for manufacturing an insulation panel of claim 17, wherein the method further comprises disposing an adjustable pressure-exerting band within the internal volume to maintain a distance, internally, between two portions of the insulation panel.

20. The method for manufacturing an insulation panel of claim 17, wherein the method further comprises disposing a reflective material on at least a portion of the insulation panel.

21. The method for manufacturing an insulation panel of claim 17, wherein the providing a panel precursor comprises extruding the panel precursor.

22. The method for manufacturing an insulation panel of claim 17, wherein the panel precursor comprises a first cross sectional shape and the insulation panel comprises a second cross sectional shape different from the first cross-sectional shape.

23. The method for manufacturing an insulation panel of claim 17, wherein reducing the pressure of the internal volume comprises evacuating the internal volume via an evacuation port.

24. A structure having insulated walls, wherein the structure comprises:
a wall; and
an insulation panel disposed within or adjacent to the wall, wherein:
the insulation panel defines an internal volume; and
the internal volume is at a lower pressure than an exterior of the insulation panel.
